(19) United States
(12) Patent Application Publication
(10) Pub. No.: US 2023/0273968 A1
(43) Pub. Date: Aug. 31, 2023

(54) INFORMATION PROCESSING APPARATUS, INFORMATION PROCESSING SYSTEM, INFORMATION PROCESSING METHOD, AND NON-TRANSITORY RECORDING MEDIUM

(71) Applicants: Mitsuo ANDO, Fukuoka (JP); Ryoji ARAKI, Fukuoka (JP)

(72) Inventors: Mitsuo ANDO, Fukuoka (JP); Ryoji ARAKI, Fukuoka (JP)

(21) Appl. No.: 18/090,544

(22) Filed: Dec. 29, 2022

(30) Foreign Application Priority Data
Jan. 31, 2022 (JP) 2022-013464
Jun. 17, 2022 (JP) 2022-097995

(51) Int. Cl. G06F 16/955; G06K 7/14; H04L 9/40; G06F 9/54

(52) U.S. Cl. CPC G06F 16/9566; G06F 9/543; G06K 7/1417; H04L 63/083

(57) ABSTRACT

An information processing apparatus includes circuitry to receive, from a terminal device, identification information associated with link setting information that is information for identifying settings corresponding to an external service, transmit, to the terminal device, an execution request to execute processing for implementing a service for uploading image data that is acquired by the terminal device, based on the identification information, and transmit, to the terminal device, the link setting information associated with the identification information to cause the terminal device to reflect the settings identified by the link setting information in additional settings for the processing for implementing the service. The processing for implementing the service being to be executed by the terminal device.

### CROSS REFERENCE TO RELATED APPLICATIONS

This patent application is based on and claims priority pursuant to 35 U.S.C. §119(a) to Japanese Patent Application Nos. 2022-013464, filed on Jan. 31, 2022, and 2022-097995, filed on Jun. 17, 2022, in the Japan Patent Office, the entire disclosures of which are hereby incorporated by reference.

### BACKGROUND

### Technical Field

The present disclosure relates to an information processing apparatus, an information processing system, an information processing method, and a non-transitory recording medium.

### Related Art

In recent years, systems that store, in a server, image data acquired by a terminal device, such as a smartphone, using an application of the server are known. Such a system stores the image data in the server by reading information embedded in, for example, a QR CODE using the terminal device, obtaining a read result, and transmitting the read result to the server. The QR code is externally provided.

### SUMMARY

An embodiment of the present disclosure includes an information processing apparatus including circuitry to receive, from a terminal device, identification information associated with link setting information that is information for identifying settings corresponding to an external service, transmit, to the terminal device, an execution request to execute processing for implementing a service for uploading image data that is acquired by the terminal device, based on the identification information, and transmit, to the terminal device, the link setting information associated with the identification information to cause the terminal device to reflect the settings identified by the link setting information in additional settings for the processing for implementing the service. The processing for implementing the service being to be executed by the terminal device.

An embodiment of the present disclosure includes an information processing system including the above-described information processing apparatus and a terminal device to display, on a display, a guide screen for uploading the image data corresponding to the external service.

An embodiment of the present disclosure includes an information processing method including receiving, from a terminal device, identification information associated with link setting information that is information for identifying settings corresponding to an external service, transmitting, to the terminal device, an execution request to execute processing for implementing a service of uploading image data acquired by the terminal device, based on the identification information, and transmitting, to the terminal device, the link setting information associated with the identification information to cause the terminal device to reflect the settings identified by the link setting information in additional settings that is for the processing for implementing the service. The processing for implementing the service is to be executed by the terminal device.

An embodiment of the present disclosure includes a non-transitory recording medium storing a plurality of instructions which, when executed by one or more processors, causes the processors to perform the above-described information processing method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a system configuration of an information processing system according to a first embodiment of the disclosure;

FIG. 2 is an illustration for describing an overview of an operation of the information processing system according to the first embodiment of the disclosure;

FIG. 3 is a block diagram illustrating an example of a hardware configuration of an information processing apparatus according to the first embodiment of the disclosure:

FIG. 4 is a block diagram illustrating a hardware configuration of a terminal device according to the first embodiment of the disclosure;

FIG. 5 is a block diagram illustrating a functional configuration of each device included in the information processing system according to the first embodiment of the disclosure;

FIG. 6 is a diagram illustrating an example of an application programming interface (API) key storage unit according to the first embodiment of the disclosure:

FIG. 7 is a diagram illustrating an example of a link management storage unit according to the first embodiment of the disclosure;

FIG. 8 is a diagram illustrating an example of a user storage unit according to the first embodiment of the disclosure;

FIG. 9 is an illustration for describing link setting information according to the first embodiment of the disclosure;

FIG. 10 is a diagram illustrating an example of the link setting information according to the first embodiment of the disclosure;

FIG. 11A is a sequence diagram illustrating an example of a process performed by the information processing system according to the first embodiment of the disclosure;

FIG. 11B is a sequence diagram illustrating an example of a process performed by the information processing system according to the first embodiment of the disclosure;

FIG. 12A is a sequence diagram illustrating an example of a process performed by the information processing system according to the first embodiment of the disclosure;

FIG. 12B is a sequence diagram illustrating an example of a process performed by the information processing system according to the first embodiment of the disclosure;

FIG. 13A is a diagram illustrating an example of a screen transition according to the first embodiment of the present disclosure;

FIG. 13B is a diagram illustrating an example of a screen transition according to the first embodiment of the present disclosure:

FIG. 14A is a sequence diagram illustrating a variation of the first embodiment of the disclosure;

FIG. 14B is a sequence diagram illustrating a variation of the first embodiment of the disclosure;

FIG. 14C is a sequence diagram illustrating a variation of the first embodiment of the disclosure;

FIG. 14D is a sequence diagram illustrating a variation of the first embodiment of the disclosure:

FIG. 14E is a sequence diagram illustrating a variation of the first embodiment of the disclosure;

FIG. 14F is a sequence diagram illustrating a variation of the first embodiment of the disclosure;

FIG. 15 is a diagram illustrating an example of link setting information according to a second embodiment of the disclosure;

FIG. 16A is a sequence diagram illustrating an example of a process performed an information processing system according to the second embodiment of the disclosure:

FIG. 16B is a sequence diagram illustrating an example of a process performed the information processing system according to the second embodiment of the disclosure:

FIG. 17 is a diagram illustrating an example of a screen transition according to the second embodiment of the disclosure;

FIG. 18 is a diagram illustrating an example of a screen transition according to the second embodiment of the disclosure:

FIG. 19 is a diagram illustrating an example of link setting information according to a third embodiment of the disclosure:

FIG. 20 is a sequence diagram illustrating a process performed by an information processing system according to the third embodiment of the disclosure:

FIG. 21 is a diagram illustrating an example of a screen transition according to the third embodiment of the disclosure;

FIG. 22 is a diagram for illustrating an example of a screen transition according to the third embodiment of the disclosure;

FIG. 23 is an illustration for describing an overview of a process performed by an information processing system according to a fourth embodiment of the disclosure;

FIG. 24 is a block diagram illustrating a functional configuration of an information processing apparatus and a terminal device according to the fourth embodiment of the disclosure:

FIG. 25 is a diagram illustrating an example of link setting information according to the fourth embodiment of the disclosure;

FIG. 26 is a sequence diagram illustrating a process performed by the information processing system according to the fourth embodiment of the disclosure:

FIG. 27A is a sequence diagram illustrating a process performed by the information processing system according to the fourth embodiment of the disclosure;

FIG. 27B is a sequence diagram illustrating a process performed by the information processing system according to the fourth embodiment of the disclosure;

FIG. 28 is a diagram illustrating an example of a screen transition according to the fourth embodiment of the disclosure: and

FIG. 29 is a diagram for illustrating an example of a screen transition according to the fourth embodiment of the disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### First Embodiment

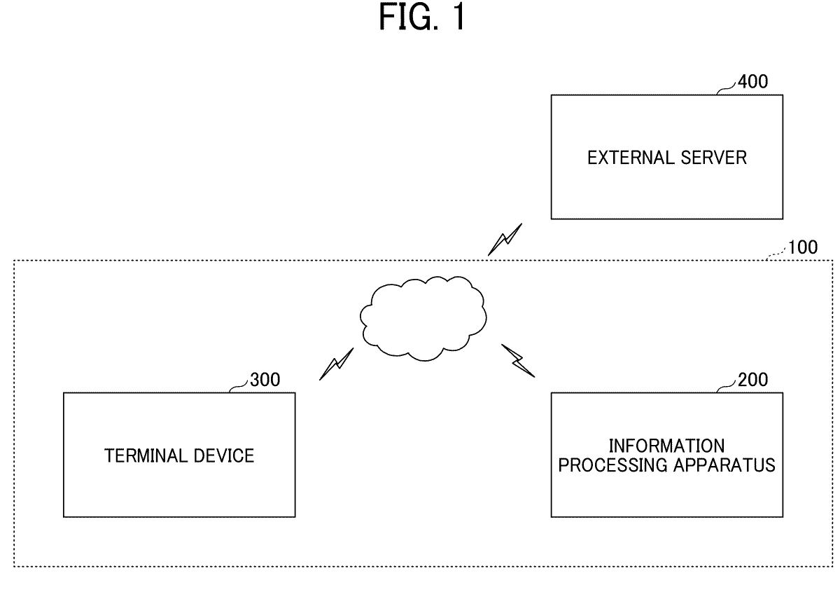

Embodiments of the present disclosure are described below with reference to drawings. FIG. 1 is a diagram illustrating an example of a system configuration of an information processing system according to a first embodiment. An information processing system 100 according to the present embodiment includes an information processing apparatus 200 and a terminal device 300. The information processing apparatus 200 and the terminal device 300 are connected to each other via a network, for example.

The information processing apparatus 200 according to the present embodiment is connected to an external server 400 that provides various types of services via a network.

In the information processing system 100 according to the present embodiment, a service provided by the information processing apparatus 200 and an external service provided by the external server 400 are linked with each other.

The external service according to the present embodiment includes, for example, a service that assists various types of management with information submitted by a user of the terminal device 300, and a service that issues a certificate using information submitted by a user of the terminal device 300.

The service provided by the information processing apparatus 200 is a service for storing, in a designated storage location, data held, or stored, by the terminal device 300 as data having a configuration supported by, appropriate to, suitable for, or corresponding to, the external service, in accordance with setting information associated with a two dimensional code read by the terminal device 300. The two dimensional code includes, for example, a QR CODE.

The setting information associated with the external service is setting information for outputting data held, or stored, by the terminal device 300 in a configuration corresponding to the external service.

Specifically, for example, the setting information includes how to use the two dimensional code in accordance with a usage scene of the external service, a type of information to be uploaded to the external server 400 by a user of the external service, and a type of information to be collected by the external server 400. The setting information may be generated in advance in the external server 400.

In the following description, the setting information associated with the external service may be referred to as link setting information. Details of the link setting information are described later. In the following description, a QR code is used as an example of the two dimensional code.

The external server 400 causes the terminal device 300 to read a QR code provided from the information processing apparatus 200. After reading the QR code, the terminal device 300 transmits to the information processing apparatus 200 a notification indicating that the QR code has been read.

In response to receiving the notification, the information processing apparatus 200 causes the terminal device 300 to execute processing for storing data that is held, or stored, by the terminal device 300 in a designated storage location, in a configuration according to link setting information associated with the QR code.

After the data output in the configuration according to the link setting information is stored in the designated storage location, the external server 400 collects the data.

In the present embodiment, as described above, the QR code is associated with the link setting information for outputting data appropriate to the external service, and the data can be provided from the terminal device to the external server.

Accordingly, according to the present embodiment, the data can be provided from the terminal device 300 to the external service without installing a specific application on the terminal device 300. In other words, the user of the terminal device 300 does not have to install such a specific application on the terminal device 300 to use the external service. In addition, according to the present embodiment, the service provided by the information processing apparatus 200 and the external service provided by the external server 400 can be linked with each other with a simple configuration.

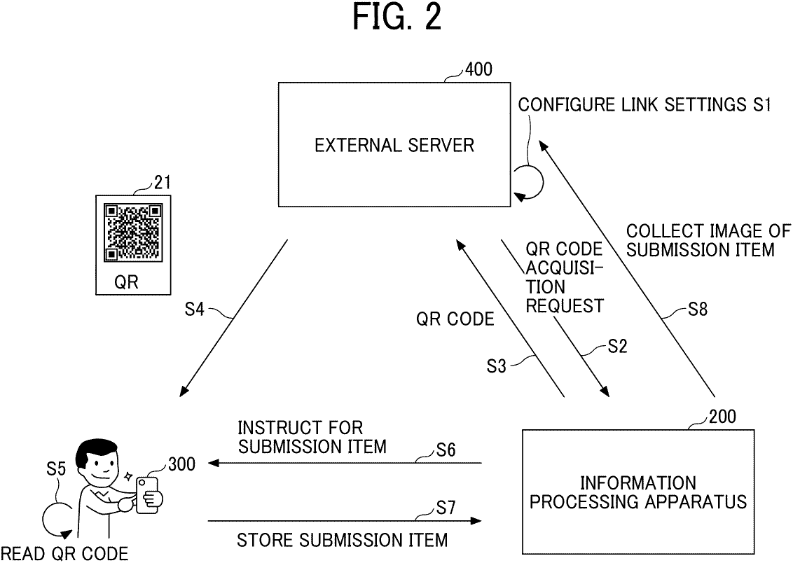

An overview of a process performed by the information processing system 100 according to the present embodiment is described below with reference to FIG. 2. FIG. 2 is an illustration for describing an overview of a process performed by the information processing system 100 according to the first embodiment of the present disclosure.

In the information processing system 100 according to the present embodiment, link setting information is generated in advance in the external server 400 (step S1).

Next, the information processing apparatus 200 receives a QR code acquisition request for acquiring a QR code from the external server 400 (step S2). In the present embodiment, the QR code acquisition request includes the link setting information.

In response to receiving the QR code acquisition request, the information processing apparatus 200 generates a QR code associated with the link setting information and provides the QR code to the external server 400 (step S3).

In response to receiving the QR code, the external server 400 provides a QR code 21 to the terminal device 300 of which a user is a user of an external service (step S4). Specifically, the external server 400 may cause a display device to display the QR code 21 so that the terminal device 300 can read the QR code 21.

When the terminal device 300 reads the QR code (step S5), the information processing apparatus 200 identifies the link setting information associated with the QR code and causes the terminal device 300 to display a screen for giving an instruction for submitting data according to the identified link setting information (step S6). In other words, the information processing apparatus 200 causes the terminal device 300 to display a screen for instructing submission of data having a configuration supported by, appropriate to, suitable for, or corresponding to, the external service.

The terminal device 300 stores data having the configuration corresponding to the external service in a storage location designated by the QR code (step S7). When the data having the configuration corresponding to the external service is stored in the designated storage location, the external server 400 collects the data (step S8).

As described above, the information processing apparatus 200 according to the present embodiment causes the terminal device 300 to read the QR code 21 associated with the link setting information generated in advance in the external server 400.

Then, the information processing apparatus 200 causes the terminal device 300 to output data having the configuration corresponding to the external service based on the link setting information and to store the data in the storage location designated by the QR code 21.

Accordingly, the user of the terminal device 300 can output the data having the configuration supported by, appropriate to, suitable for or corresponding to, the external service by simply reading the QR code 21. In addition, the external server 400 can collect the data having the configuration supported by, appropriate to, suitable for, or corresponding to, the external service by setting the link setting information and collecting the data from the designated storage location.

Accordingly, the user of the terminal device 300 does not have to generate data in accordance with a configuration supported by, appropriate to, suitable for, or corresponding to, the external service, and can automatically submit data having the configuration supported by, appropriate to, suitable for, or corresponding to, the external service.

The user of the terminal device 300 may also be referred to as a user of the external service.

In addition, a provider of the external service does not have to check whether the data submitted by the user is in the configuration corresponding to the external service, or to modify the data submitted by the user so as to make the data be in the configuration corresponding to the external service.

As described above, according to the present embodiment, the external service provided by the external server 400 and the service provided by the information processing apparatus 200 are linked with each other by a simple procedure.

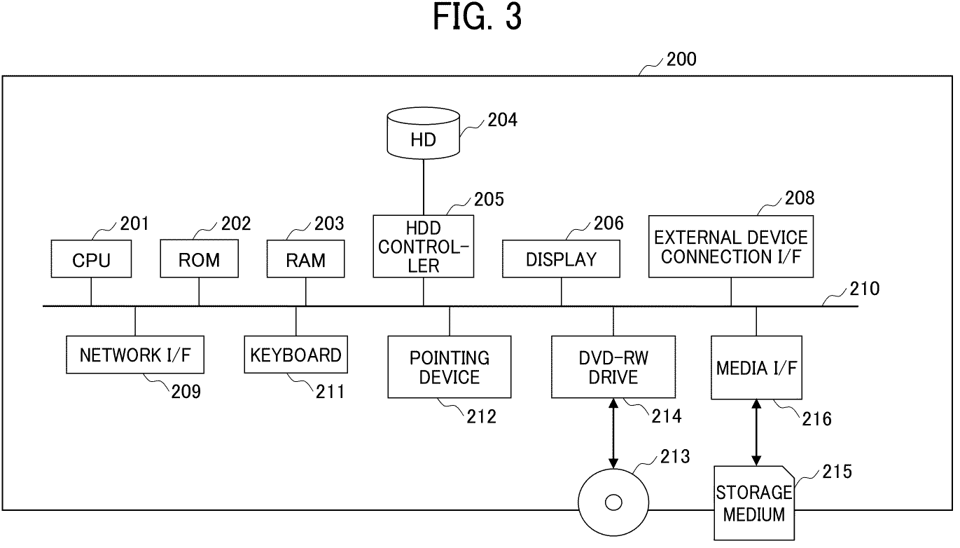

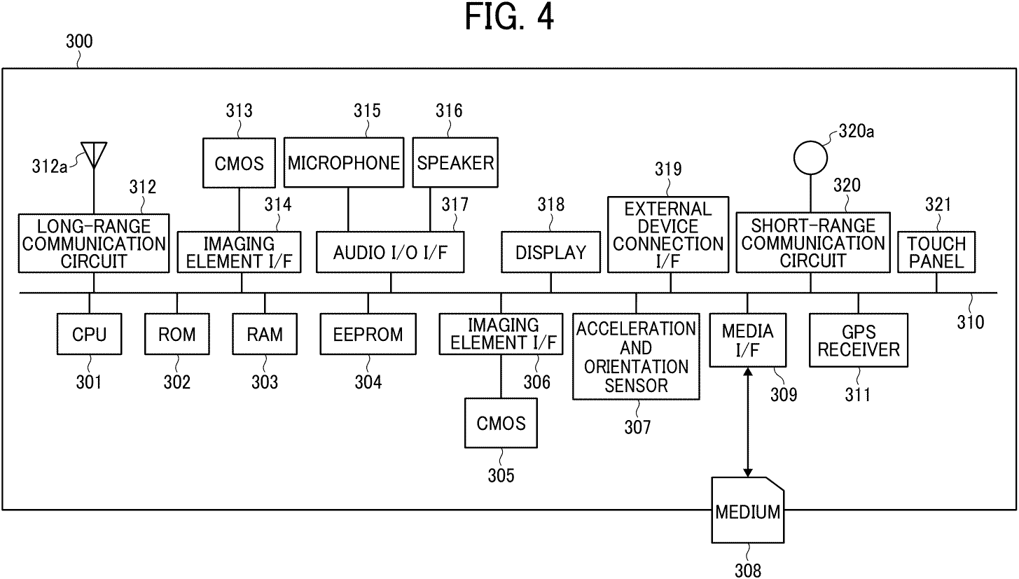

A hardware configuration of each apparatus (device) included in the information processing system 100 according to the present embodiment is described below with reference to FIG. 3 and FIG. 4.

FIG. 3 is a block diagram illustrating an example of a hardware configuration of the information processing apparatus 200 according to the present embodiment of the disclosure. As illustrated in FIG. 3, the information processing apparatus 200 includes a central processing unit (CPU) 201, a read only memory (ROM) 202, a random access memory (RAM) 203, a hard disk (HD) 204, a hard disk drive (HDD) controller 205, a display 206, an external device connection interface (I/F) 208, a network I/F 209, a data bus 210, a keyboard 211, a pointing device 212, a digital versatile disc rewritable (DVD-RW) drive 214, and a media I/F 216.

The CPU 201 controls the overall operation of the information processing apparatus 200. The ROM 202 stores a program such as an initial program loader (IPL) used for driving the CPU 201. The RAM 203 is used as a work area for the CPU 201. The HD 204 stores various data such as a control program. The HDD controller 205 controls reading and writing of various data from and to the HD 204 under control of the CPU 201. The display 206 displays various information such as a cursor, menu, window, character, or image. The external device connection I/F 208 is an interface for connecting various external devices. Examples of the external devices include, but not limited to, a universal serial bus (USB) memory and a printer.

The network I/F 209 is an interface for performing data communication using a communication network. The data bus 210 is an address bus or a data bus that electrically connects the elements illustrated in FIG. 3. such as the CPU 201. to each other.

The keyboard 211 is an example of an input device provided with a plurality of keys for allowing a user to input characters, numerals, or various instructions. The pointing device 212 is an example of an input device that allows a user to select or execute a specific instruction, select a target for processing, or move a cursor being displayed. The DVD-RW drive 214 reads or writes various data from or to a DVD-RW 213, which is an example of a removable storage medium. The removable storage medium is not limited to the DVD-RW and may be a Digital Versatile Disc-Recordable (DVD-R) or the like. The media I/F 216 controls reading or writing (storage) with respect to a recording medium 215 such as a flash memory.

A hardware configuration of the terminal device 300 according to the present embodiment is described below with reference to FIG. 4. FIG. 4 is a block diagram illustrating a hardware configuration of the terminal device 300 according to the present embodiment.

The terminal device 300 according to the present embodiment can be any suitable device as long as having an image capturing function, such as a smartphone. In the example of FIG. 4, a smartphone is used as an example of the terminal device.

The terminal device 300 includes a CPU 301, a ROM 302, a RAM 303, an electrically erasable PROM (EEPROM) 304, a complementary metal oxide semiconductor (CMOS) sensor 305, an imaging element I/F 306, an acceleration and orientation sensor 307, a media I/F 309, and a global positioning system (GPS) receiver 311.

The CPU 301 controls the overall operation of the terminal device 300 The ROM 302 stores a program such as an IPL used for driving the CPU 301.

The RAM 303 is used as a work area for the CPU 301. The EEPROM 304 reads or writes various data such as a control program for a smartphone under control of the CPU 301. The CMOS sensor 305 is an example of a built-in imaging device that captures a subject under control of the CPU 301 to obtain image data. In alternative to the CMOS sensor 305, an imaging element such as a charge-coupled device (CCD) sensor may be used. The imaging element I/F 306 is a circuit that drives the CMOS sensor 305. The acceleration and orientation sensor 307 includes various sensors such as an electromagnetic compass or gyrocompass for detecting geomagnetism and an acceleration sensor. The media I/F 309 reads or writes (stores) data from or to a recording medium 308 such as a flash memory or the like. The GPS receiver 311 receives a GPS signal from a GPS satellite.

The terminal device 300 further includes a long-range communication circuit 312, a CMOS sensor 313, an imaging element I/F 314, a microphone 315, a speaker 316, an audio input/output (I/O) I/F 317, a display 318, an external device connection interface I/F 319, a short-range communication circuit 320, an antenna 320a of the short-range communication circuit 320, and a touch panel 321.

The long-range communication circuit 312 is a circuit that communicates with other devices through a communication network. The CMOS sensor 313 is an example of a built-in imaging device that captures a subject under control of the CPU 301 to obtain image data. The imaging element I/F 314 is a circuit that drives the CMOS sensor 313. The microphone 315 is a built-in circuit that converts sound into an electric signal. The speaker 316 is a built-in circuit that generates audio such as music or voice by converting an electric signal into physical vibration. The audio I/O I/F 317 is a circuit for controlling input and output of audio signals between the microphone 315 and the speaker 316 under control of the CPU 301. The display 318 is an example of a display device that displays an image of the object, various icons, etc. Examples of the display 318 include a Liquid Crystal Display (LCD) and an organic Electro Luminescence (EL) display. The external device connection I/F 319 is an interface for connecting to various external devices. The short-range communication circuit 320 is a communication circuit that communicates in compliance with the Near Field Communication (NFC), the Bluetooth, or the like. The touch panel 321 is an example of an input device that allows a user to input a user instruction to the terminal device 300 through touching a screen of the display 318.

The terminal device 300 also includes a bus line 310. The bus line 310 is an address bus or a data bus, which electrically connects the hardware resources illustrated in FIG. 4 such as the CPU 301.

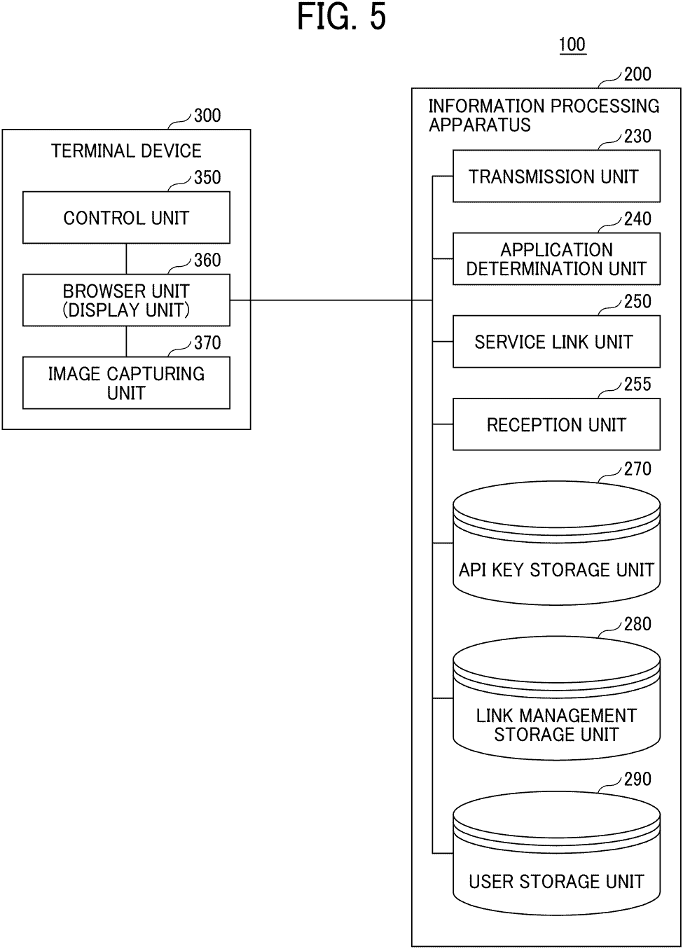

A functional configuration of each apparatus (device) included in the information processing system 100 is described below with reference to FIG. 5. FIG. 5 is a block diagram illustrating a functional configuration of each apparatus (device) included in the information processing system 100 according to the present embodiment of the disclosure.

Functional units of the information processing apparatus 200 are described below. The information processing apparatus 200 according to the present embodiment includes a transmission unit 230, an application determination unit 240, a service link unit 250, and a reception unit 255. Each of the functional units is implemented by the CPU 201 reading and executing the program.

The information processing apparatus 200 according to the present embodiment further includes an application programming interface (API) key storage unit 270, a link management storage unit 280. and a user storage unit 290

The transmission unit 230 and the reception unit 255 perform processing for establishing communication between the information processing apparatus 200 and the terminal device 300, and processing for establishing communication between the information processing apparatus 200 and the external server 400, for example.

The application determination unit 240 give a reaction to an initial access uniform resource locator (URL). In response to access to the initial access URL, the application determination unit 240 refers to the link management storage unit 280 to determine an application corresponding to information (for example, touch point ID) given to the initial access URL.

When determining an application that corresponds to the information given to the initial access URL, the application determination unit 240 transmits a response including a redirect request including a URL for the application to an access source of the initial access URL.

The service link unit 250 is one of applications that implements a service provided by the information processing apparatus 200. Specifically, the service link unit 250 is a service for uploading data from among the data stored in the terminal device 300, according to the link setting information.

More specifically, the service implemented by the service link unit 250 is a service that, when the QR code 21 is read, causes the terminal device 300 to activate the image capturing function and upload image data of an image captured by the image capturing function to the information processing apparatus 200.

In addition, in response to receiving the link setting information and the QR code acquisition request from the external server 400, the service link unit 250 generates a QR code associated with the link setting information and provides the QR code to the external server 400.

The API key storage unit 270 is an information storage unit that manages a key for a provider of an external service to use an API of the service link unit 250. The link management storage unit 280 is an information storage unit that manages information for associating the QR code with the link setting information. The user storage unit 290 is an information storage unit that manages a user who uses the service link unit 250.

Next, functional units of the terminal device 300 are described below. The terminal device 300 includes a control unit (operating system unit) 350, a browser unit 360, and an image capturing unit 370. Each of the functional units is implemented by processing executed by the CPU 301 according to one or more programs installed on the terminal device 300.

The control unit 350 activates the browser unit 360 in response to an operation performed by the user of the terminal device 300. The browser unit 360 is, for example, a general web browser, and executes processing according to HyperText Markup Language (HTML) data or a script (for example, JAVASCRIPT). When being activated, the browser unit 360 transmits the initial access URL to the information processing apparatus 200.

At this time, the browser unit 360 transmits a touch point ID assigned to the initial access URL to the information processing apparatus 200 along with the initial access URL. The touch point ID includes identification information for identifying a service, and is associated with an application (service link unit 250) that implements the service, in advance.

In addition, the browser unit 360 accesses an application associated with the touch point ID among the applications included in the information processing apparatus 200 according to the redirect request from the information processing apparatus 200 in response to the access to the initial access URL. The redirect request is a response from the information processing apparatus 200 in response to access to the initial access URL

The browser unit 360 acquires data (for example, HTML data, script) indicating a processing execution request to the terminal device 300 from the accessed application.

The image capturing unit 370 implements the image capturing function to obtain image data, by controlling, by the CPU 301, a camera implemented by, for example, the CMOS sensor 305, the CMOS sensor 313 or a CCD sensor to capture an image of a subject.

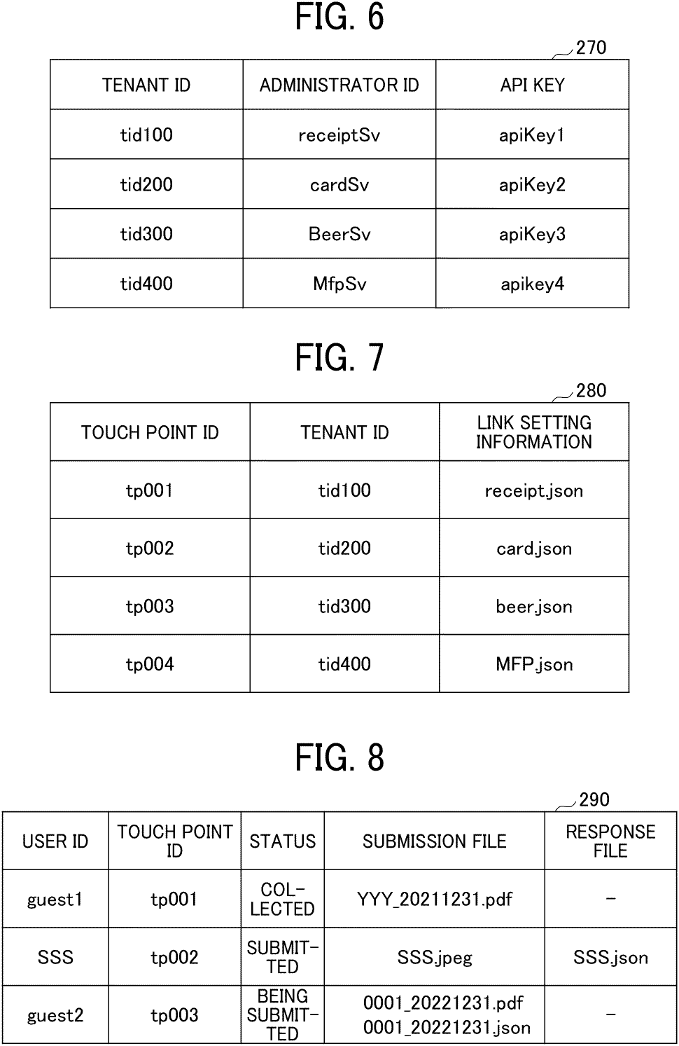

Each of the storage units included in the information processing apparatus 200 is described below with reference to FIGS. 6 to 8. FIG. 6 is a diagram illustrating an example of the API key storage unit 270 according to the present embodiment of the disclosure.

The API key storage unit 270 according to the present embodiment includes information items of tenant ID. administrator ID, and API key, and the item of “tenant ID” is associated with the other items. In the following description, a record of information including values of the items, “tenant ID,” “administrator ID,” and “API key,” in the API key storage unit 270 may be referred to as API key information.

The value of the item of “tenant ID” is identification information for identifying a provider of an external service. In other words, the value of the item of “tenant ID” is identification information for identifying an external service. In the following description, the provider of the external service may be referred to as a tenant . The provider of the external service includes an individual person, a company, and an organization.

The value of the item of “administrator ID” is identification information for identifying an administrator who has authority to use an API key in a tenant. The value of the item of “API key” is a key used when a tenant cooperates with the information processing system 100, and the number of API keys assigned to for each tenant is one.

FIG. 7 is a diagram illustrating an example of the link management storage unit 280 according to the present embodiment of the disclosure. The link management storage unit 280 according to the present embodiment includes information items of touch point ID. tenant ID, and link setting information, and the item of “touch point ID” is associated with the other items. A record of information including values of the items, “touch point ID,” “tenant ID,” and “link setting information,” in the link management storage unit 280 may be referred to as link management information.

The value of the item of “touch point ID” is identification information for identifying a QR code generated by the service link unit 250, and is included in the QR code.

The value of the item of “link setting information” is information for identifying link setting information included in a QR code. Specifically, for example, a file name of the link setting information is included. In addition, for example, identification information, a file path, an identification number, and a name are included. As for a data format of the link setting information according to the present embodiment, for example, a JavaScript Object Notation (JSON) format or another format may be used.

Accordingly, the touch point ID according to the present embodiment is information for associating the link setting information with the QR code, and is information included in the QR code. The touch point ID according to the present embodiment is information associated with the external service, and can also be referred to as identification information for identifying the link setting information.

In addition, in the link management storage unit 280, a tenant ID and link setting information are associated with each other for each touch point ID.

FIG. 8 is a diagram illustrating an example of the user storage unit 290 according to the present embodiment of the disclosure. The user storage unit 290 according to the present embodiment includes information items of user ID, touch point ID, status, submission file, and response file, and the item of “user ID” is associated with the other items.

A record of information in which a value of the item of “user ID” is associated with values of the other items in the user storage unit 290 may be referred to as user information.

The value of the item of “user ID” is identification information for identifying a user of a service provided by the information processing apparatus 200. In other words, the value of the item of “user ID” is identification information for identifying a user of the terminal device 300.

In a case that an authentication method set in the link setting information is guest authentication, the user ID is a user ID starting with “guest,” and in a case that an authentication method set in the link setting information is oauth authentication, the user ID is a user ID of an authentication server of a redirect destination.

The value of the item of “status” indicates a status of data as being viewed from the user. The value of the item of “submission file” indicates a file name of data transmitted (submitted) from the terminal device 300 to the information processing apparatus 200.

The value of the item of “response file” indicates a file name of data transmitted from the provider of the external service to the user.

In the example of FIG. 8, a user identified by a user ID of “guest 1” has read a QR code including a touch point ID of “tp001” with the terminal device 300, and has transmitted data of “YYY_20211231.pdf” to the information processing apparatus 200. In addition, the external server 400 has already collected the information submitted by the user identified by the user ID of “guest 1.”

In the following description, the data having a configuration corresponding to an external service transmitted from the terminal device 300 to the information processing apparatus 200 may be referred to as a submission item.

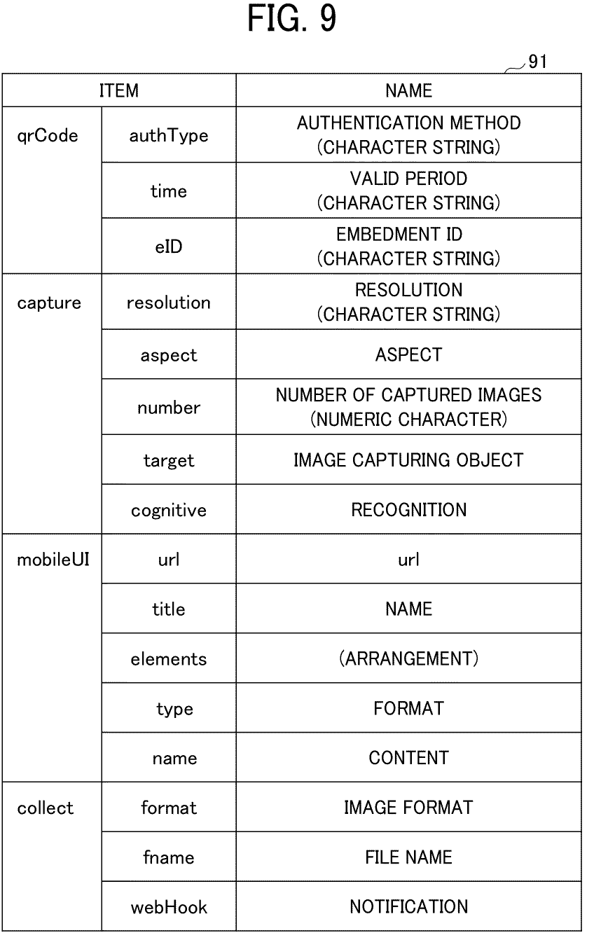

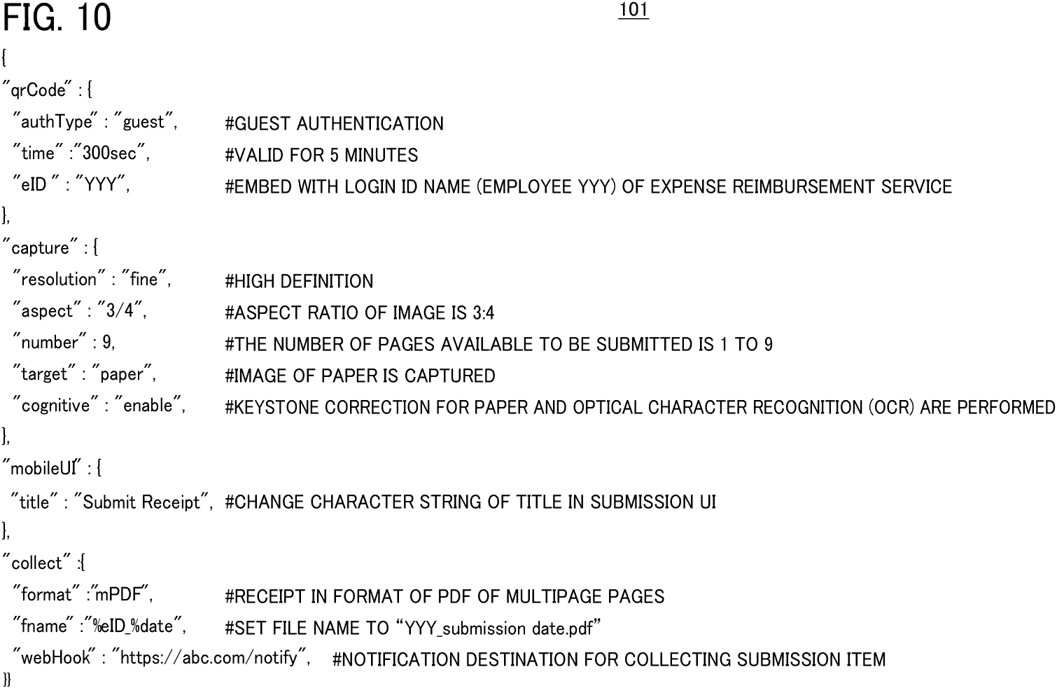

The link setting information according to the present embodiment is described below with reference to FIG. 9. FIG. 9 is an illustration for describing the link setting information according to the present embodiment. In the example of FIG. 9. a list of setting items of the link setting information of the link setting information set by the external server 400.

The setting items according to the present embodiment include items of “qrCode,” “capture,” “mobileUI,” and “collect,” and setting items are further provided for each of the item.

The item of “qrCode” includes setting items of “oauthType,” “time,” and “eID” that are associated with the QR code. In the example of use mode, the item of “oauthType” is a required setting item among the setting items, but may not be a required setting item depending on the usage mode. In addition, the setting items in this item are set in a case that the code is a QR code. Regarding this, similar or the substantially same setting items can be set for a code other than a QR code. In other words, this item can be said to be an item including setting items associated with the code.

At the item of “oauthType,”’ an authentication method is set. Examples of the authentication method include a method of acquiring and using authentication information of a providing source of an external service (link authentication) and a method of performing authentication by redirecting to a providing source of an external service (oauth authentication).

As an authentication method, for example, there is a method of using user authentication unique to the information processing apparatus 200. In this case, an authentication screen is displayed on the terminal device 300 when the QR code is read.

In addition, examples of the authentication method include a method using a QR code that can be used only once (one time authentication), a method of authenticating as a guest without requiring input of an account (guest authentication), a method of authenticating by inputting a password or a code and checking whether the password or the code matches a preset password or a temporarily issued code (password or code authentication), and a method of authenticating by inputting a secret password and checking whether the secret password matches a preset secret password (secret password authentication). The setting of the authentication method is not limited to the above-described methods, and any other authentication methods may be set.

At the item of “time,” a valid period of the QR code is set. The valid period includes a unit of second, a unit of date, and no valid period (unlimited).

At the item of “eID,” individual information associated with data (submission item) in a configuration applicable to the external service is set. The individual information is submission item identification information for identifying a submission item The individual information set in the item may be a character string having one character to one hundred characters, namely a character string having one or more characters, but less than 101 characters.

With respect to the item of “capture,” settings related to image capturing and a submission item are configured. In other words, with respect to the item of “capture,” settings related to data output from the terminal device 300 are configured. The setting items associated with the item of “capture” include items of “resolution,” “aspect,” “number,” “target,” and “cognitive.” Among the items, there is no required item, and whether to set the settings can be determined by the provider of the external service.

At the item of “resolution,” a resolution used in capturing an image of a submission item by the image capturing function of the camera included in the terminal device 300 is set At the item of “aspect,” an aspect ratio of image data to be submitted is set. Specifically, at the item of “aspect,” when a fraction of an integer is set, the fraction is set as the aspect ratio. When “free” is set at the item of “aspect,” the aspect ratio is set by a person who takes a photo corresponding to the image data (the user of the terminal device 300).

At the item of “number,” the number of image sheets corresponding to the submission item of which an image is to be captured is set. In this embodiment, the number of image sheets is set as a value equal to or greater than 1 and less than 10.

At the item of “target,” an image capturing object of which an image is to be captured by the image capturing function of the terminal device 300 is set. In the present embodiment, the image capturing object may be set by selecting from among “paper,” “face,” “beerbox,” and “other”

When “paper” is selected as the image capturing object, the image capturing object is “paper.” At this time, an item of “title,” which is described later, may be automatically set to “Submit Sheet of Paper.” When “face” is selected as the image capturing object, the image capturing object is “face.” At this time, the item of “title,” which is described later, may be automatically set to “Face Photo.”

When “beerbox” is selected as the image capturing object, the image capturing object is “beerbox.” At this time, the item of “title,” which is described later, may be automatically set to “Beer Box.” When “other” is selected, the image capturing object is “other.”

At the item of “cognitive,” whether to perform recognition processing with respect to an image capturing object in image data is set. When “enable” is selected at the item of “cognitive,” the recognition processing with respect to the image capturing object is set to be performed.

In this case, as a specific example of the recognition processing, when the image capturing object is “paper,” “paper” is recognized based on the image data, and processing including four-corners determination, which determining whether an image of four corners of “paper” is included in an image represented by the image data or not, keystone correction, and character recognition is performed. When the image capturing object is “face,” the background of a face image is removed and the face image is shaped to have the aspect ratio set to the item of “aspect.” If the image data does not include a face image even though the image capturing object is “face,” capturing an image again is instructed. Accordingly, as the recognition processing set with the item of “cognitive,” different recognition processing may be performed according to the image capturing object and the settings related to the image capturing.

With respect to the item of “mobileUl,” settings related to a guide screen for causing the terminal device 300 to output image data corresponding to an external service are configured. In other words, with respect to the item of “mobileUl,” settings related to a screen of the terminal device 300 displayed when a submission item is submitted to the service link unit 250 are configured.

The setting items associated with the item of “mobileUI” include items of “url,” “title,” “elements,” “type,” and “name.” Among the items, there is no required item, and whether to set the settings can be determined by the provider of the external service

At the item of “url,” a URL of a web application (hereinafter referred to as a web app) for the terminal device 300 is set in a case where a screen (user interface) is configured without using a template. In the present embodiment, when a URL of a web application is set to the item of “url,” the other setting items in the subsequent stage are disabled.

At the item of “title,” a character string indicating a title of a screen displayed on the terminal device 300 is set. In the present embodiment, the title of the screen can be changed from a preset character string by setting a value of the item of “title.” The character string may be one that has 1 to 100 characters, namely having one or more characters, but less than 101 characters.

At the item of “elements,” a display item to be displayed on the screen is set. At the item of “type,” a format of a display item displayed on the screen is set. Specifically, when “text” is set to the item of “type,” an input field for an answer to a display item displayed on the screen is displayed. In addition, when “message” is set to the item of “type,” the display item displayed on the screen is displayed as a message and the input field for an answer is not displayed.

At the item of “name,” a character string that is the content of a display item to be displayed on the screen is set.

The character string may be one that has 1 to 100 characters, namely having one or more characters, but less than 101 characters.

With respect to the item of “collect,” settings related to collection of a submission item is configured. The setting items associated with the item of “collect” include items “format,” “fname,” and “webHook.” Among the items, there is no required item, and whether to set the settings can be determined by the provider of the external service.

At the item of “format,” a format of submission item collected by the external server 400 is set. Specifically, in a case where “mPDF” is set to the item of “format,” a format of submission item is a portable document format (PDF) of multiple pages. When “sPDF” is set to the item of “format,” a format of submission item is pdf data of a single page.

When “jpeg” is set to the item of “format,” a format of submission item is jpeg data. When “orignal” is set to the item of “format,” a format of submission item is not changed.

At the item of “fname,” a file name of the submission item is set. Specifically, when “%eID” is set to the item of “fname,” a character string set as the item of “eID” is the file name of the submission item. In addition, when “%date” is set to the item of “fnan1e,” a date when the submission item is submitted is a file name of the submission item. When “%UID” is set to the item of “fname,” a user ID of the user who logs in to the external service is a file name of the submission item.

At the item of “webHook,” a URL to which completion of submission of a submission item is to be notified is set. Note that a method of notifying that a submission item has been submitted may be a method other than notification by webHook.

The above-described setting items are an item list set as the link setting information. In the present embodiment, the above-described setting items are set by the provider of the external service and associated with the QR code, so that data received from the terminal device 300 can be provided to the external server 400 as data having a configuration corresponding to the external service.

An example of the link setting information according to the present embodiment is described below with reference to FIG. 10. FIG. 10 is a diagram illustrating an example of the link setting information according to the first embodiment.

Link setting information 101 illustrated in FIG. 10 is an example of the link setting information set by the external server 400 in a case that the external service provided by the external server 400 is an expense reimbursement service. A file name of the link setting information 101 is, for example, “receipt.json.”

In the link setting information 101 illustrated in FIG. 10, as settings related to a QR code, “guest authentication” is set to the item of “oauthType,” as a valid period of 300 seconds (5 minutes) is set to the item of “time,” and a character string “YYY” is set to the item of “eID.” In addition, “eID” illustrated in FIG. 10 is a name of a user who logs in to the expense reimbursement service, which is an example of the external service.

In addition, in the link setting information 101, as settings related to a submission item, a resolution of image data is set to “high definition” at the item of “resolution,” and an aspect ratio of the image data is set to 3:4 at the item of “aspect.” In addition, in the link setting information 101, nine pieces of image data are set to the item of “number” as a setting related to a submission item. In other words, in the link setting information 101. the number of pages that can be submitted is any of 1 to 9.

To the item of “target,” “paper” is set as an image capturing object, and to the item of “cognitive,” “enable” is set. In the present embodiment, the keystone correction processing and the character recognition processing are set to the recognition processing to be performed with respect to the image capturing object.

In addition, in the link setting information 101, as a setting related to a screen of the terminal device 300 in submitting a submission item, “receipt submission” as a title of the screen is set to the item of “title.”

In addition, in the link setting information 101. as settings related to collection of the submission item, pdf data of multiple pages is set to the item of “format,” and a file name of the submission item is set to “eID_% date” at the item of “fname.” In other words, in the link setting information 101, the name of the user of the external service and the date on which the submission item is submitted are the file name of the submission item.

In addition, in the link setting information 101, a URL, “http://abc...,” which is a notification destination, to which completion of submission of the submission item is to be notified is set to the item of “webHook.”

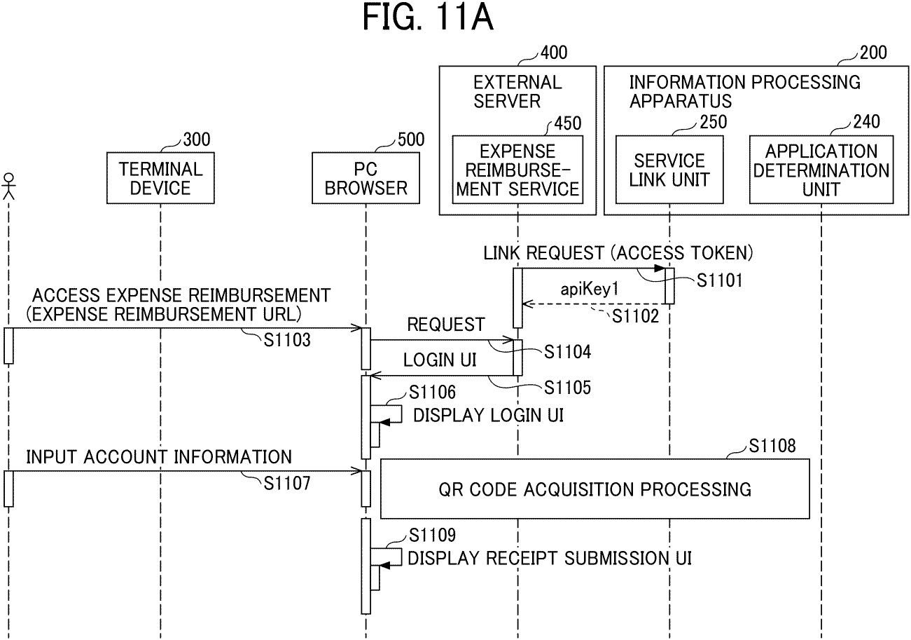

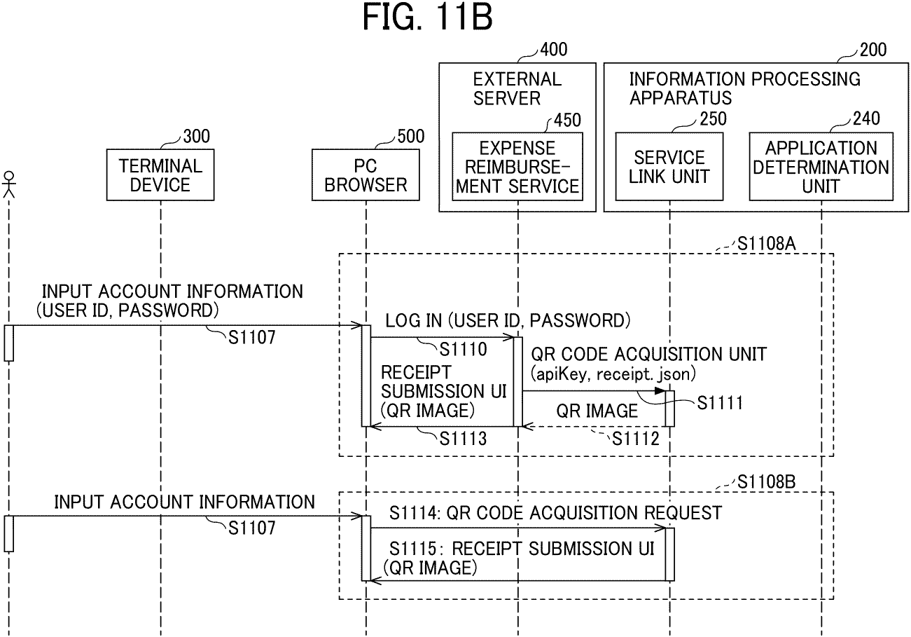

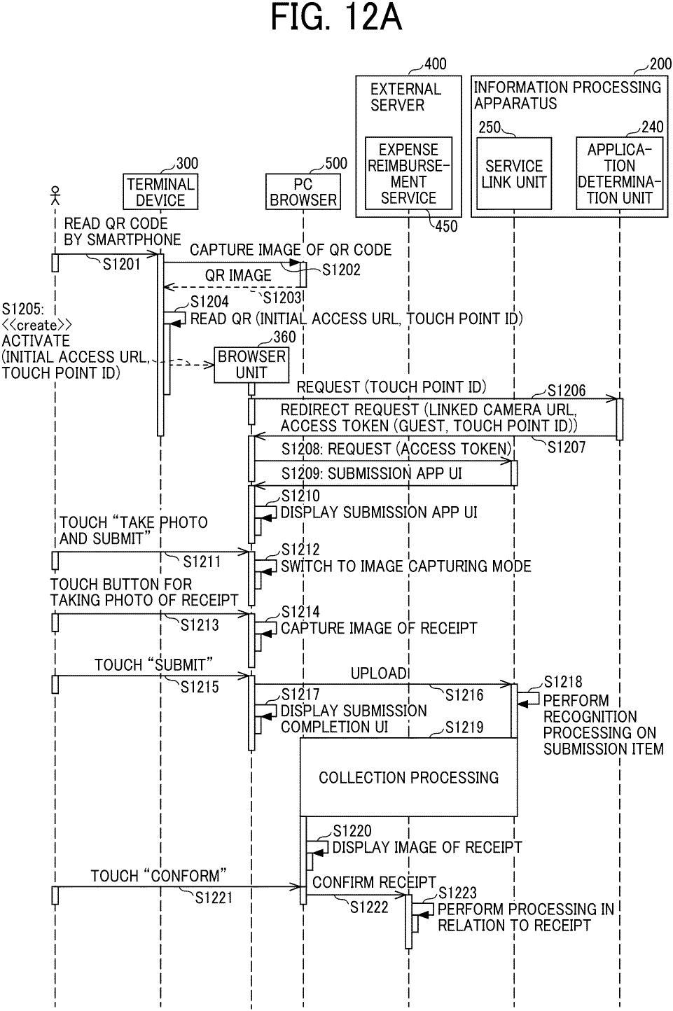

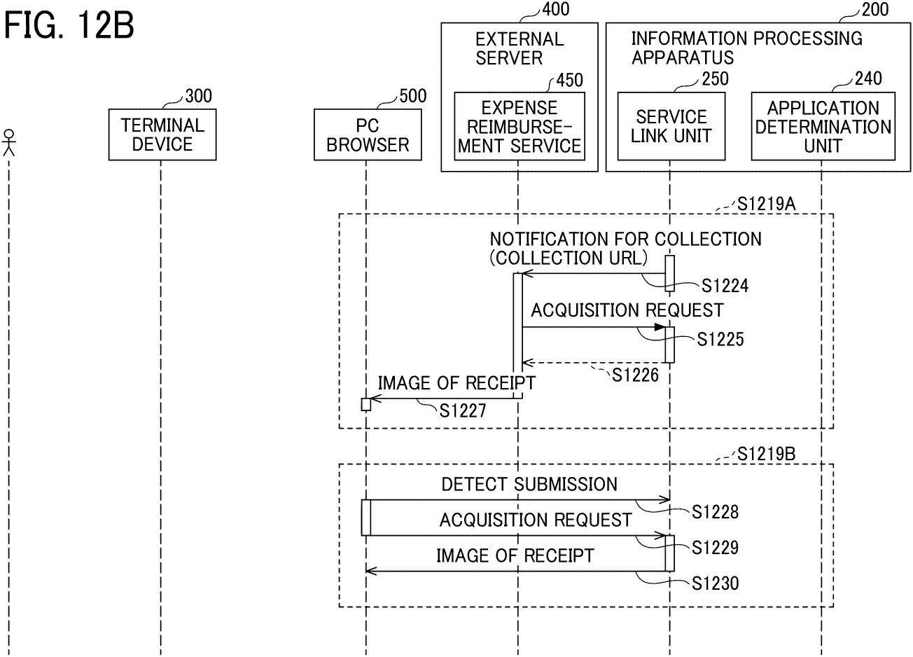

Next, processes performed by the information processing system 100 according to the present embodiment is described with reference to FIGS. 11A, 11B, 12A, and 12B. FIG. 11A is a sequence diagram illustrating an example of a process performed by the information processing system 100 according to the first embodiment. Referring to FIG. 11A, the process in which the information processing apparatus 200 provides a QR code including a touch point ID to an expense reimbursement service 450 is described.

In the present embodiment, the external service provided by the external server 400 is the expense reimbursement service 450, and the link setting information 101 is set by the external server 400.

First, an administrator of the expense reimbursement service 450 provided by the external server 400 acquires a tenant ID and an administrator ID, and requests the service link unit 250 to acquire an access token for linking (step S1101).

In the description of the present embodiment, the tenant ID is “tid100,” and the administrator ID is “receiptSv.”

The service link unit 250 refers to the API key storage unit 270 and transmits an API key corresponding to a combination of the tenant ID and the administrator ID to the expense reimbursement service 450 (step S1102).

The API key corresponding to the combination of the tenant ID of “tid100” and the administrator ID of “receiptSv” is “apikey1” (see FIG. 6). Accordingly, the service link unit 250 transmits “apikey1” to the expense reimbursement service 450.

Subsequently, YYY who is a user of the expense reimbursement service 450 accesses a URL of the expense reimbursement service 450 from a personal computer (PC) browser 500 for performing expense reimbursement (step S1103). The PC browser 500 may be a browser installed in a general computer used by YYY in a company.

The PC browser 500 makes a connection request to the expense reimbursement service 450 (step S1104). In response to receiving the connection request, the expense reimbursement service 450 transmits information (for example, HTML, Cascading Style Sheets (CSS), JAVASCRIPT) for displaying a login screen to the PC browser 500 (step S1105).

The PC browser 500 displays the login screen for logging in to the expense reimbursement service 450 according to the received information (step S1106).

Next, when the PC browser 500 receives an input of account information for logging in from the user of the expense reimbursement service 450 (step S1107), the PC browser 500 acquires a QR code from the service link unit 250 (step S1108).

When acquiring the QR code, the PC browser 500 displays a receipt submission screen including the QR code (step S1109). The receipt submission screen is a screen for submitting a receipt.

In the present embodiment, there are two ways of processing in which the PC browser 500 acquires the QR code. Each way of processing is described below with reference to FIG. 11B. FIG. 11B is a sequence diagram illustrating an example of a process performed by the information processing system 100 according to the first embodiment.

Step S1108A in FIG. 11B is a first way of processing for making a QR code acquisition request to the service link unit 250 via the expense reimbursement service 450.

In this case, the PC browser 500 transmits the account information to the expense reimbursement service 450 and requests for authentication, namely transmits an authentication request (step S1110). The account information is a user ID (YYY) and a password for logging in to the expense reimbursement service 450.

After performing authentication in response to the authentication request, the expense reimbursement service 450 makes a QR code acquisition request to the service link unit 250 of the information processing apparatus 200 (step S1111).

The QR code acquisition request includes the API key and the link setting information 101 (receipt.json) set in the expense reimbursement service 450. In this example, the user ID of “YYY” input to the PC browser 500 is set at the item of “eID” of receipt.json.

The service link unit 250 receives the QR code acquisition request, generates a QR code associated with receipt.json, and transmits image data representing the QR code to the expense reimbursement service 450 (step S1112).

Specifically, the service link unit 250 generates a touch point ID that is associated with receipt.json. Then, the service link unit 250 generates the QR code including the touch point ID and an initial access URL, and responds to the expense reimbursement service 450 with the image data representing the QR code.

At this time, the service link unit 250 stores the touch point ID. receipt.json, and the tenant ID associated with the API key of the expense reimbursement service 450 in the link management storage unit 280 in association with each other.

In the present embodiment, the service link unit 250 generates the touch point ID of “tp001 .”

In addition, the tenant ID associated with the API key “apikey1” of the expense reimbursement service 450 is “tid100.”

Accordingly, the service link unit 250 stores the touch point ID of “tp001,” the tenant ID of “tid100.” and the link setting information of “receipt.json” in association with each other in the link management storage unit 280 (see FIG. 7).

Although the service link unit 250 according to the present embodiment generates the touch point ID and associates the API key with the tenant ID in response to the QR code acquisition request, the present embodiment is not limited to this. The touch point ID may be generated in advance and may be stored in the link management storage unit 280 in association with the API key and the tenant ID. In this case, in response to receiving the QR code acquisition request, the service link unit 250 may acquire the touch point ID associated with the API key and the tenant ID and adds the touch point ID to the QR code.

In response to receiving the image data representing the QR code, the expense reimbursement service 450 transmits to the PC browser 500 a display instruction to display the receipt submission screen including the QR code (step S1113).

In the present embodiment, the service link unit 250 transmits the image data representing the QR code to the expense reimbursement service 450, but the present disclosure is not limited to this. In some embodiments, the service link unit 250 may transmit to the expense reimbursement service 450 a notification indicating that generation of the image data of the QR code associated with the expense reimbursement service 450 is successful. In this case, the expense reimbursement service 450 transmits to the PC browser 500 a notification indicating that generation of the image data of the QR code is successful. In response to receiving the notification, the PC browser 500 displays the receipt submission screen including the QR code.

In addition, the service link unit 250 according to the present embodiment may update the link setting information by overwriting the link setting information associated with the touch point ID in response to receiving an overwrite request to overwrite the QR code.

The above is the first way of processing in which the PC browser 500 acquires the QR code. Next, a second way of processing in which the PC browser 500 acquires the QR code is described.

Step S1108B in FIG. 11B is a second way of processing for making a QR code acquisition request to the service link unit 250 via the expense reimbursement service 450. In the second way of processing, the PC browser 500 makes a QR code acquisition request without going through the expense reimbursement service 450.

In this case, the PC browser 500 makes the QR code acquisition request to the service link unit 250 (step S1114).

At this time, the API key and receipt.json included in the QR code acquisition request may be acquired in advance by the PC browser 500.

In response to receiving the QR code acquisition request, the service link unit 250 generates a QR code associated with receipt.json and transmits image data representing the QR code to the PC browser 500 (step S1115). The processing of the service link unit 250 in response to receiving the QR code acquisition request is substantially the same as that of step S1108A.

In the information processing system 100 according to the present embodiment, the PC browser 500 requests to acquire a QR code and receives the QR code as a response for the request. This results in reducing the number of accesses to the external server 400 that implements the expense reimbursement service 450. In other words, the external server 400 can reduce processing for linking the expense reimbursement service 450 and the service link unit 250, and the linking is easily set.

FIG. 12A is a sequence diagram illustrating an example of a process performed by the information processing system 100 according to the first embodiment. The process illustrated in FIG. 12A is performed after the QR code including the touch point ID is generated.

The terminal device 300 receives an operation for reading the QR code included in the receipt submission screen displayed on the PC browser 500 (step S1201), and reads the QR code (step S1202, step S1203). The operation for reading the QR code is, for example, a user operation of holding the terminal device 300 over the QR code displayed on the receipt submission screen.

Upon reading the QR code, the terminal device 300 notifies the user of the terminal device 300 that the QR code has been read (step S1204), and activates the browser unit 360 (step S1205).

In response to the activation, the browser unit 360 automatically transmits a Hypertext Transfer Protocol (HTTP) request to the application determination unit 240 corresponding to the initial access URL embedded in the QR code (step S1206). The HTTP request includes the touch point ID acquired from the QR code.

The application determination unit 240 of the information processing apparatus 200 transmits a redirect request to the browser unit 360 (step S1207). The redirect request includes a URL of the service link unit 250 and an access token.

In this example, guest authentication is set to the authentication method that is a setting item of the link setting information 101 (receipt.json) associated with the touch point ID. Accordingly, the application determination unit 240 refers to the setting items associated with the QR code of the link setting information 101 (receptacle.json) associated with the touch point ID in the link management storage unit 280, and the guest ID of “guest” and the touch point ID of “tp001” are included in the access token.

In response to receiving the redirect request, the browser unit 360 makes a connection request to the service link unit 250 (step S1208).

In response to receiving the connection request, the service link unit 250 identifies, from the link management storage unit 280, the link setting information 101 (receipt.json) that is associated with the touch point ID in the link management storage unit 280 and refers to the settings related to a guide screen for outputting image data appropriate to the external service corresponding to the identified link setting information 101 (receipt.json). Then, the service link unit 250 responds, to the browser unit 360. with a character string indicating a title of a screen to be displayed on the terminal device 300 as information for displaying the receipt submission screen (step S1209). In other words, the service link unit 250 transmits at least a part of the link setting information 101 to the browser unit 360.

Based on the information, the browser unit 360 displays the character string on the receipt submission screen displayed on a screen of the terminal device 300, thereby displaying the receipt submission screen reflecting the settings related to a screen in the link setting information 101 (step S1210).

As described above, by transmitting the link setting information 101 associated with the touch point ID to the terminal device 300, the settings related to a guide screen identified by the link setting information 101 can be reflected by settings for processing for implementing the service to be executed by the terminal device.

In response to receiving an operation for proceeding to submission of a receipt from the user of the terminal device 300 (step S1211), the browser unit 360 switches to an image capturing mode to capture an image of an item corresponding to the submission item (step S1212).

In response to receiving an operation for capturing an image (step S1213), the browser unit 360 causes the image capturing function of the camera of the terminal device 300 to capture an image of the receipt and temporarily stores image data representing the captured image of the receipt (step S1214).

In the setting items related to image capturing and a submission item in the link setting information 101 (receipt.json) associated with the touch point ID, the resolution in capturing an image of an item corresponding to a submission item by the image capturing function of the camera included in the terminal device 300, the aspect ratio of an image to be submitted, and the number of image sheets corresponding to the submission item of which an image is to be captured are set.

The browser unit 360 receives an operation for capturing an image, and refers to the settings related to image capturing and a submission item in order to output image data appropriate to the external service corresponding to the link setting information 101 (receipt.json) associated with the touch point ID. Then, the browser unit 360 captures images corresponding to the number of images set, with the resolution and the aspect ratio of the submission item according to the settings related to image capturing and a submission item, by the capturing function of the camera included in the terminal device 300, thereby acquiring the images reflecting the settings related to image capturing and a submission item in the link setting information 101. In the case of capturing multiple images, an operation of continuously capturing an image of the submitted item is performed.

As described above, by transmitting the link setting information 101 associated with the touch point ID to the terminal device 300, the settings related to image capturing identified by the link setting information 101 can be reflected by settings for processing for implementing the service to be executed by the terminal device.

Subsequently, in response to receiving an operation for submitting the submission item (step S1215), the browser unit 360 uploads the captured image data to the service link unit 250 along with the access token (step S1216).

At this time, the service link unit 250 may generate a URL indicating a storage location in which the image data (submission item) obtained after performing the recognition processing on the uploaded image data is stored. In addition, the URL may be set in advance in the ser%,-ice link unit 250.

Subsequently, the browser unit 360 displays a screen indicating that the submission of the image data is completed, and then ends the display (step S1217).

The service link unit 250 performs the recognition processing on the image data based on receipt.json associated with the touch point ID stored in the access token (step S1218).

In the present embodiment, regarding the setting of an image capturing object in the link setting information 101 (receipt.json) associated with the touch point ID, “paper” is set to the image capturing object. In addition, “enable” is set to the setting indicating whether to perform recognition processing with respect to an image capturing object in image data in the link setting information 101 (receipt.json) associated with the touch point ID. In addition, the keystone correction processing and the character recognition processing are set to the recognition processing to be performed with respect to the image capturing object in the image data. Accordingly, in step S1218, the recognition processing is performed on the image data.

In addition, regarding the setting of a file name of the submission item in the link setting information 101 (receipt.json) associated with the touch point ID, a combination of a user ID of a user who currently logs in to the external service and date of the submission are set to a file name of the submission item.

Accordingly, the image data uploaded as a submission item is stored so as to have a file name of “XXX__20211231.pdf” indicating a name of the user and the date. In addition, the service link unit 250 recognizes an image of a sheet of paper included in the image data, and performs the keystone correction processing and the character recognition processing.

In other words, the service link unit 250 sets, or adjusts, the image data transmitted from the browser unit 360 to have a configuration corresponding to the expense reimbursement service 450.

Subsequently, the service link unit 250 performs collection processing for causing the expense reimbursement service 450 to collect the image data having the configuration corresponding to the expense reimbursement service 450 (step S1219). Details of the collection processing are described later.

The PC browser 500 displays a confirmation screen that is a screen for confirming the collected image data (step S1220). In response to receiving an operation indicating that the image data displayed on the confirmation screen has been confirmed (step S1221), the PC browser 500 transmits a notification indicating that the confirmation of the image data has been completed to the expense reimbursement service 450 (step S1222).

The expense reimbursement service 450 receives the notification and performs processing for expense reimbursement (step S1223).

In the present embodiment, there are two ways of collection processing in which the expense reimbursement service 450 collects the image data output in the configuration corresponding to the expense reimbursement service 450. Each way of processing is described below with reference to FIG. 12B. FIG. 12B is a sequence diagram illustrating an example of a process performed by the information processing system 100 according to the first embodiment.

Step S1219A in FIG. 12B is a first way of processing for collecting the image data performed by the expense reimbursement service 450.

In this case, the service link unit 250 identifies receipt.json associated with the touch point ID and notifies a URL, which is a notification destination, that the submission item has been submitted, based on the setting items of the identified receipt.json (step S1224).

In the present embodiment, regarding the setting related to collection of a submission item in the link setting information 101 (receipt.json) associated with the touch point ID, a URL to be notified that the submission item has been submitted is set. Accordingly, the service link unit 250 notifies to the URL, which is a notification destination, set in the link setting information 101, that the submission item has been submitted.

The notification may include a URL indicating a storage location in which the submission item is temporarily stored by the service link unit 250. In other words, the URL indicating the storage location in which the submission item is temporarily stored is a URL indicating a storage location of the data having the configuration corresponding to the external service.

In the following description, the URL indicating the storage location in which the submission item is temporarily stored may be referred to as a collection URL. A valid period may be assigned to the collection URL.

In response to the notification, the expense reimbursement service 450 make an acquisition request to the collection URL in order to acquire the image data (step S1225).

The service link unit 250 transmits the image data, “XXX_20211231.pdf,” which is data stored in the configuration corresponding to the expense reimbursement service 450, to the expense reimbursement service 450 (step S1226).

The expense reimbursement service 450 checks whether the file name of the received image data, “XXX_20211231.pdf” matches the user ID of the user who currently logs in to the expense reimbursement service 450, and if the file name and the user ID match, transmits the image data to the PC browser 500 (step S1227).

The above is the first way of processing for collecting the image data performed by the expense reimbursement service 450. Next, a second a second way of processing in which the expense reimbursement service 450 collects the image data is described.

Step S1219B in FIG. 12B is a second way of processing for collecting the image data performed by the expense reimbursement service 450. In the second way of processing, the image data is directly displayed on the PC browser 500 without going through the expense reimbursement service 450.

In this case, the PC browser 500 detects whether the image data of which the file name matches the user ID of the user who currently logs in to the expense reimbursement service 450 is stored in the collection URL or not (step S1228).

When detecting that the image data of which the file name matches the user ID of the user who currently logs in to the expense reimbursement service 450 is stored in the collection URL, the PC browser 500 makes an acquisition request to the collection URL in order to acquire the image data (step S1229). In response to the request, the service link unit 250 transmits to the PC browser 500, the image data, “XXX__20211231.pdf,” stored in the configuration corresponding to the expense reimbursement service 450 (step S1230).

In the present embodiment, the image data can be transmitted from the service link unit 250 to the PC browser 500 as described above.

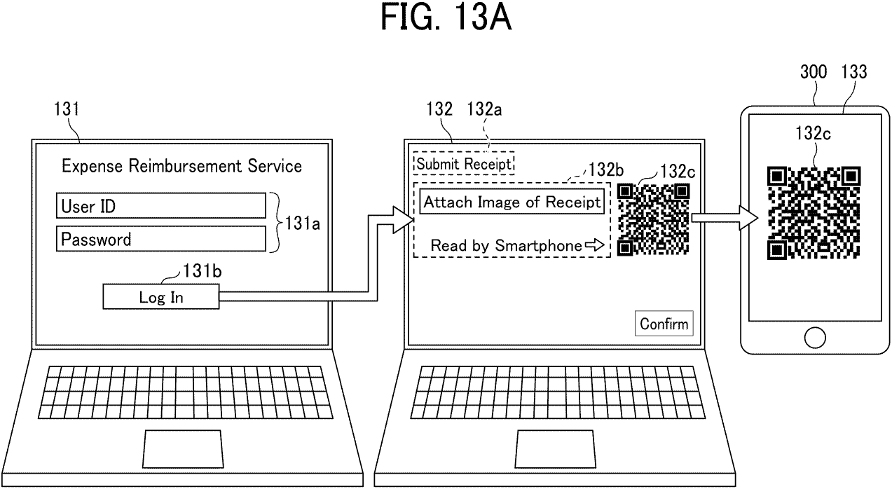

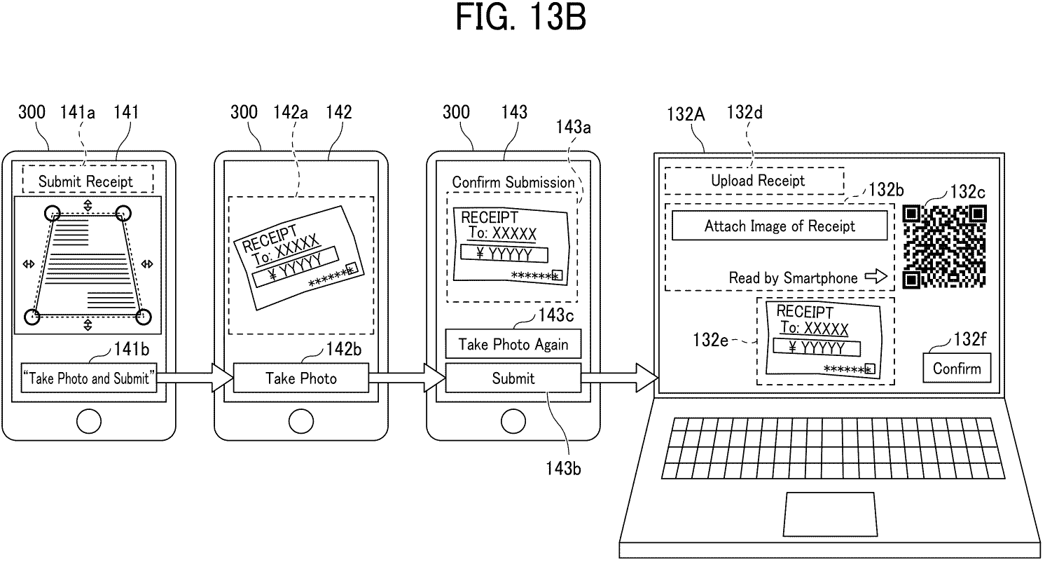

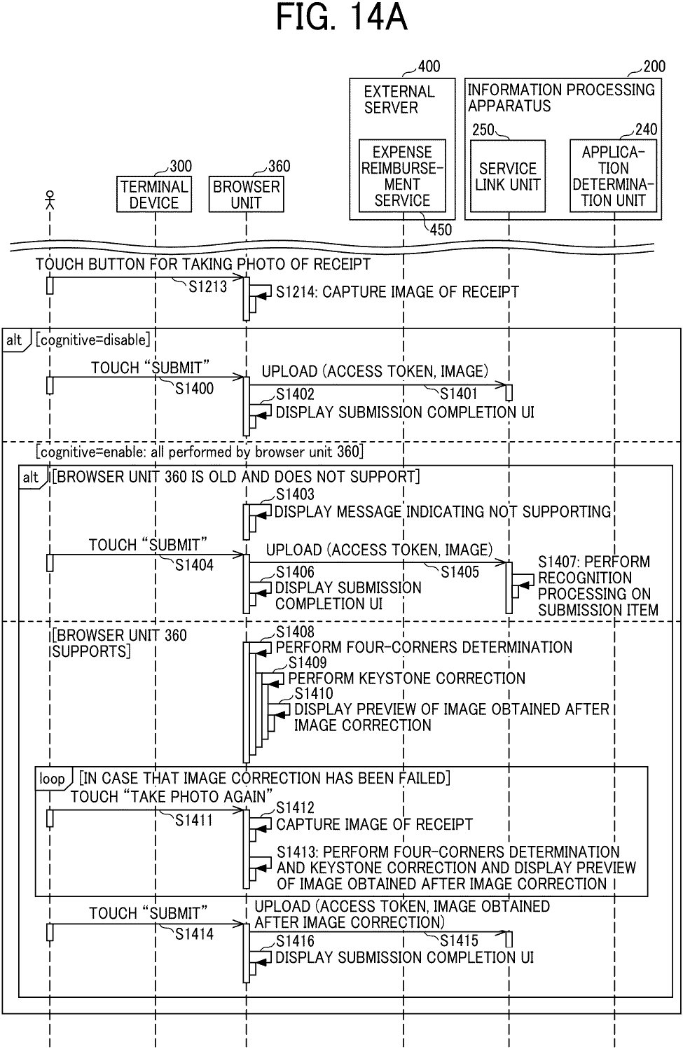

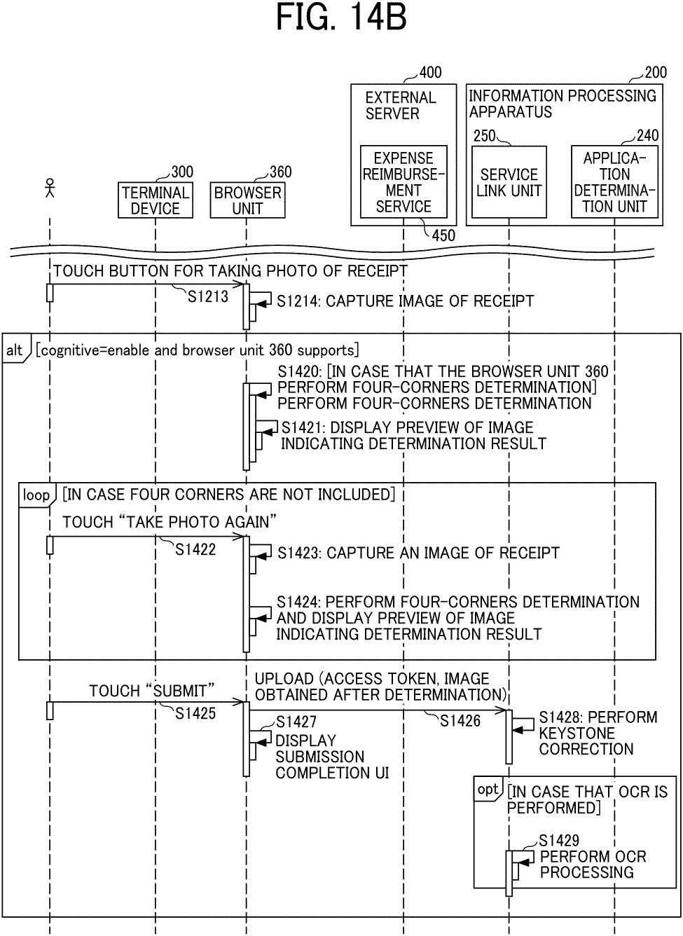

Next, screen transitions of the PC browser 500 and the browser unit 360 according to the present embodiment are described with reference to FIGS. 13A and 13B.

FIG. 13A is a diagram illustrating an example of a screen transition according to the first embodiment. A screen 131 illustrated in FIG. 13A is an example of a login screen that is a screen for logging in to the expense reimbursement service 450, and is displayed on the PC browser 500 in step S1106 of 11A.

The screen 131 includes a set of input fields 131a for inputting account information and an operation button 131b for making a QR code acquisition request.

When the account information is input to the set of input field s131a, and the operation button 131b is operated on the screen 131, the PC browser 500 makes a QR code acquisition request.

A screen 132 is an example of the receipt submission screen including the QR code, and is displayed on the PC browser 500 in step S1109 in FIG. 11A.

The screen 132 includes display areas 132a and 132b, and a QR code 132c. In the display area 132a, a screen title, “Submit Receipt,” set at a setting related to a guide screen to output image data corresponding to an external service, set in receipt.json is displayed.

In the display area 132b, a message for instructing submission of the image data representing a captured receipt and a message for instructing reading the QR code 132c by the terminal device 300 are displayed, for example . The QR code 132c is a QR code generated by the service link unit 250.

A screen 133 is an example of a screen displayed by the browser unit 360 when the terminal device 300 reads the QR code 132c, and is displayed by the browser unit 360 in step S1205 in FIG. 12A. The QR code 132c is displayed on the screen 133.

FIG. 13B is a diagram illustrating an example of a screen transition according to the first embodiment. A screen 141 illustrated in FIG. 13B is an example of the receipt submission screen, and is displayed by the browser unit 360 in step 12A of FIG. S1210.

The screen 141 includes a display area 141a and an operation button 141b. In the display area 141a, a character string “Submitted Receipt” is displayed as a title of the screen. The character string displayed in the display area 141a is described below.

In the present embodiment, in receipt.json illustrated in FIG. 10, “paper” is set as the value of the item of “target” of the item of “capture,” and “receipt submission” is set as the value of the item of “title.”

Accordingly, in the display area 141a, the title of the screen is changed to “Submitted Receipt,” but not the preset title, “Submit Sheet.”

The operation button 141b is an operation button for switching the terminal device 300 to an image capturing mode. When the operation button 141b is operated on the screen 141, the terminal device 300 is switched to the image capturing mode and a screen 142 is displayed.

The screen 142 illustrates an example of a screen when the terminal device 300 is in the image capturing mode. The screen 142 includes a display area 142a and an operation button 142b. An image to be captured by the camera of the terminal device 300 is displayed in the display area 142a. The operation button 142b is an operation button for capturing an image displayed in the display area 142a to obtain image data.

When the operation button 142b is operated on the screen 142, the terminal device 300 captures an image in the display area 142a and causes the browser unit 360 to display a screen 143. On the screen 142, an image of a receipt is displayed in the display area 142a, and when the operation button 142b is operated, the image of the receipt is captured.

The screen 143 is an example of a screen for uploading the captured image data to the service link unit 250. The screen 143 includes a display area 143a and operation buttons 143b and 143c. In the display area 143a, the captured image of the receipt is displayed.

The operation button 143b is an operation button for uploading (transmitting) the image data displayed in the display area 143a to the service link unit 250. In other words, the operation button 143b is an operation button for causing the service link unit 250 to submit the image data of the receipt. The operation button 143c is an operation button that is operated when another image is to be subsequently captured.

When the operation button 143b is operated on the screen 143, the browser unit 360 transmits the image data of the receipt to the service link unit 250.

When the image data of the receipt is received, the service link unit 250 causes the PC browser 500 to display a screen for allowing the user of the expense reimbursement service 450 to confirm the image of the receipt submitted.

A screen 132A illustrated in FIG. 13B is an example of the confirmation screen of the image data collected by the expense reimbursement service 450, and is displayed on the PC browser 500 in step 12A S1220.

The screen 132A includes the display area 132b. the QR code 132c, display areas 132d, 132e, and an operation button 132f.

In the display area 132d, a message indicating that the image of the receipt has been uploaded is displayed. In the display area 132e, the image of the receipt uploaded to the service link unit 250 is displayed. The operation button 132f is an operation button for submitting the image data displayed in the display area 132e to the expense reimbursement service 450.

When an operation of selecting the operation button 132f is performed on the screen 132A, the PC browser 500 may request the expense reimbursement service 450 to execute processing for expense reimbursement.

As described above, in the present embodiment, the QR code including the touch point ID associated with the link setting information set in the external service is generated and provided to the external service, in advance, and this allows the service provided by the service link unit 250 and the external service to be linked with each other.

In the present embodiment, the user of the external service can submit the image data without installing a special application on the terminal device 300.

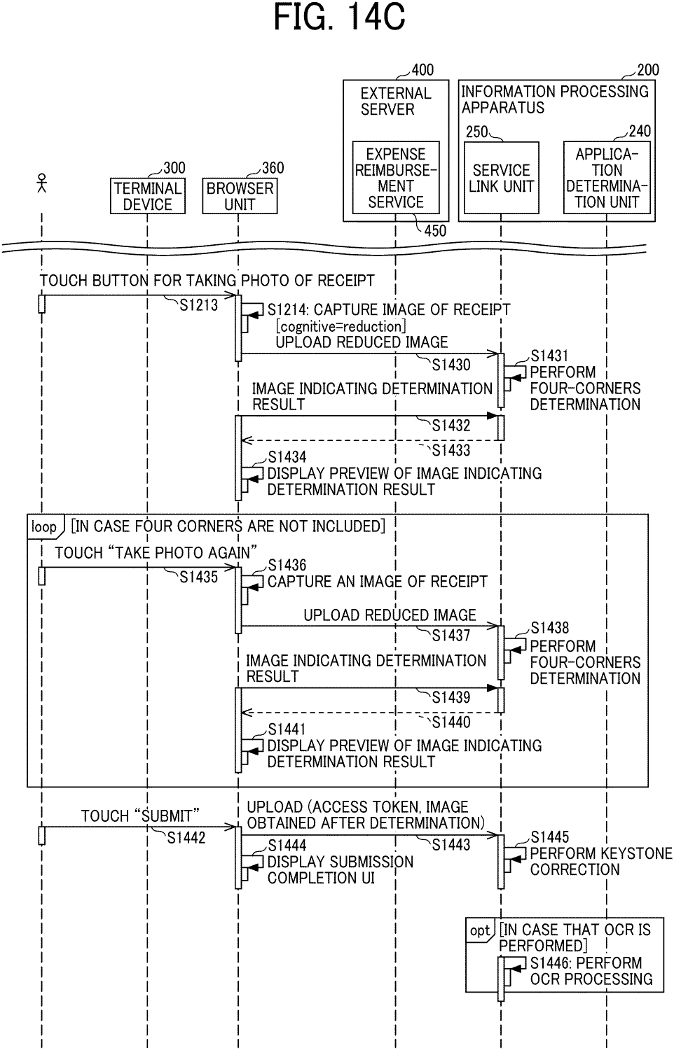

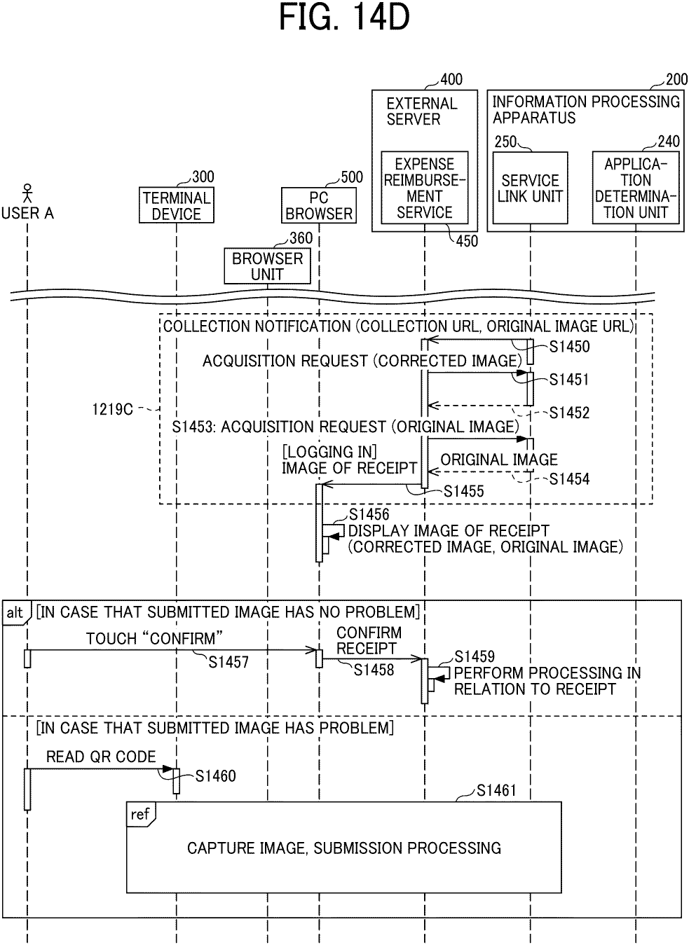

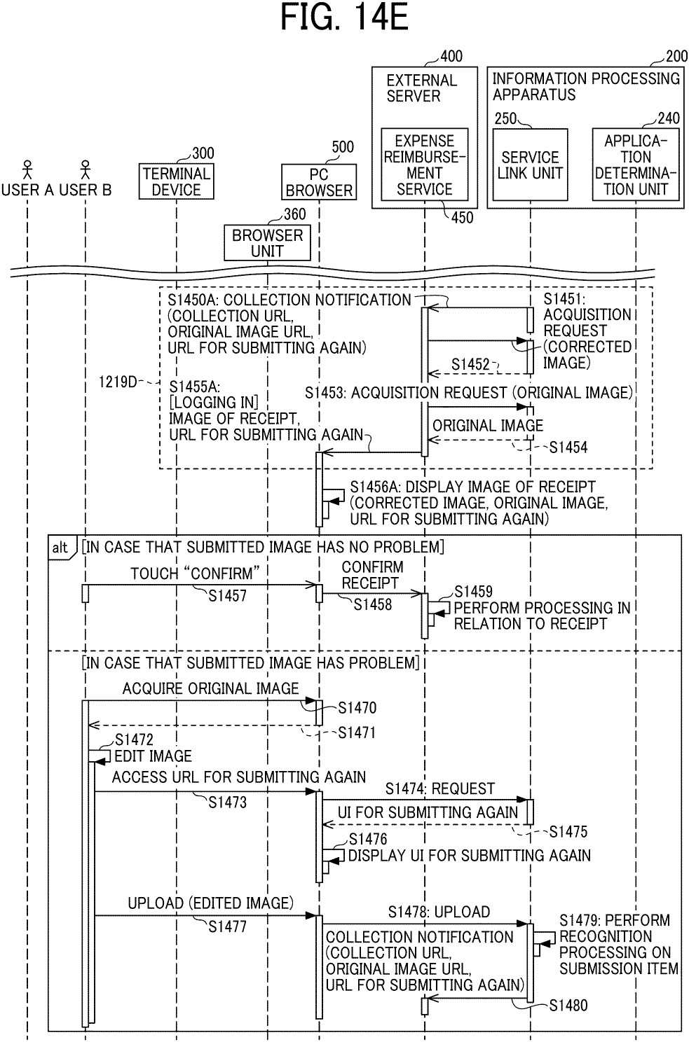

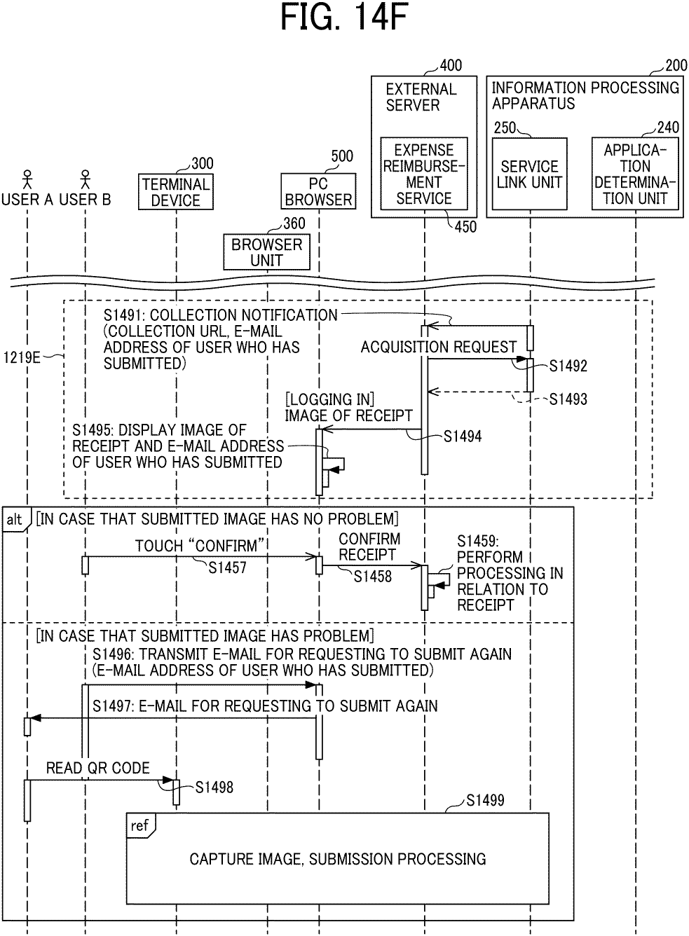

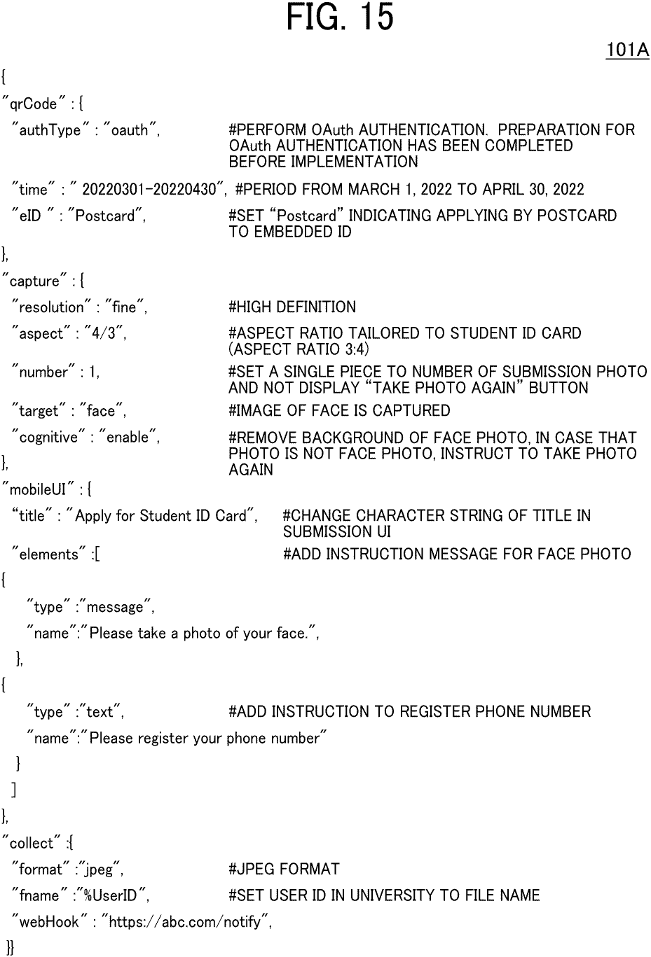

Next, examples of variations of the present embodiment are described with reference to FIGS. 14A to 14F.

### Variation 1:

In Variation 1, the link setting information 101 is set so that the recognition processing with respect to the image capturing object (image data) is performed by the browser unit 360 of the terminal device 300.

Specifically, in Variation 1, “enable: all performed by the browser unit 360” is set to the item of “cognitive,” which is a setting item associated with the item of “capture” in the link setting information 101 (see FIGS. 9 and 10).

In Variation 1, it is assumed that the four-corners determination processing and the keystone correction processing are set to the recognition processing to be performed with respect to the image capturing object. Accordingly, in Variation 1, both the four-corners determination processing and the keystone correction processing are performed by the browser unit 360.

A process performed by the information processing system 100 according to Variation 1 is described below with reference to FIG. 14A.

FIG. 14A is a sequence diagram illustrating a variation (Variation 1) of the first embodiment. In Variation 1, the processing from receiving an operation for reading the QR code by the terminal device 300 to temporary storing the image data of the receipt of which an image is captured by the image capturing function is substantially the same as that in 12A. In other words, in Variation 1, processing from step S1400 illustrated in FIG. 14 is performed after the processing from step S1201 to step S1214 in FIG. 12A is performed.

Processing from step S1400 to step S1402 in FIG. 14A indicates processing performed in a case where “disable” is set to the item of “cognitive,” which is a setting item associated with the item of “capture” in the link setting information 101.

Processing of S1400 to S1402 illustrated in FIG. 14A is substantially the same as the processing of S1215 to S1217 illustrated in FIG. 12A, and the description of the processing of S1400 to S1402 illustrated in FIG. 14A is omitted, accordingly. In the example illustrated in FIG. 14A, the recognition processing is not performed on the image data uploaded to the service link unit 250 in step S1401.

The processing performed by the information processing system 100 after step S1402 is substantially the same as the processing after step S1219 in FIG. 12A.

In FIG. 14A, processing from step S1403 to step S1406 is performed, in a case where “enable: all performed by the browser unit 360” is set to the item of “cognitive,” which is a setting item associated with the item of “capture” in the link setting information 101.

In addition, processing from step S1403 to step S1407 in FIG. 14A is performed in the case where “enable: all performed by the browser unit 360” is set to the item of “cognitive,” but the browser unit 360 does not have a function of performing recognition processing on image data.

In this case, when the image data representing the captured image of the receipt is temporarily stored in step S1214, the browser unit 360 displays a message (non-support message) indicating that the browser unit 360 does not have a function of performing recognition processing on image data (step S1403), and the process proceeds to step S1404.

Since the processing from step S1404 to step S1407 in FIG. 14A is substantially the same as the processing from step S1215 to step S1218 in FIG. 12A,the description thereof is omitted.

Subsequent to step S1406, the process performed by the information processing system 100 proceeds to step S1411, which is described later.

Processing from step S1408 to step S1416 in FIG. 14A indicates processing performed in a case where “enable: all performed by the browser unit 360” is set to the item of “cognitive” in the link setting information 101, and the browser unit 360 has a function of performing recognition processing on image data.

In this case, when the image data representing the captured image of the receipt is temporarily stored in step S1214, the browser unit 360 refers to the link setting information 101 (receipt.json) associated with the touch point ID and performs the four-corners determination processing for determining whether the image represented by the image data includes four corners of image of the receipt (step S1408).

Subsequently, the browser unit 360 performs the keystone correction processing on the image data (step S1409), and displays a preview image of image obtained after the keystone correction processing (step S1410).

In a case where the correction of the image data has failed, the browser unit 360 receives an operation for capturing an image of the receipt again (step S1411). The case where the correction of the image data has failed may be, for example, a case where the image represented by the image data does not include the four corners of image of the receipt. In this case, the browser unit 360 may cause the terminal device 300 to display guide information for prompting the user to capture an image of the receipt again.

The browser unit 360 causes the camera function of the terminal device 300 to capture an image of the receipt (step S1412) to obtain image data, performs the four-corners determination processing and the keystone correction processing on the image data, and displays a preview image of image obtained after the keystone correction processing (step S1413).

Subsequently, in response to receiving an operation for submitting a submission item (step S1414), the browser unit 360 uploads the image data representing the image obtained after the keystone correction processing to the service link unit 250 along with the access token (step S1415).

Subsequently, the browser unit 360 displays a screen indicating that submission of the image data is completed (step S1416).

The processing performed by the information processing system 100 after step S1416 is substantially the same as the processing after step S1219 in FIG. 12A.

As described above, in Variation 1, when the browser unit 360 has the function of performing recognition processing on image data, the browser unit 360 can perform the recognition processing on the image data.

### Variation 2:

In Variation 2, the link setting information 101 is set so that the browser unit 360 of the terminal device 300 performs a part of the recognition processing on the image capturing object (image data).

Specifically, in Variation 2, “enable: xxxx” is set to the item of “cognitive,” which is a setting item associated with the item of “capture” in the link setting information 101, and the browser unit 360 is caused to perform the “xxxx” processing among the recognition processing on the image data (see FIGS. 9 and 10). The recognition processing other than “xxxx” processing performed on the image data is performed by the service link unit 250.

In the following, a case where “enable: four-corners determination” is set to the item of “cognitive” of the link setting information 101 is described.

In Variation 2, it is assumed that the four-corners determination processing, the keystone correction processing, and the character recognition processing are set to the recognition processing to be performed with respect to the image capturing object. Accordingly, in Variation 2, the four-corners determination processing is performed by the browser unit 360, and the keystone correction processing and the character recognition processing are performed by the service link unit 250.

A process performed by the information processing system 100 according to Variation 2 is described below with reference to FIG. 14B.

FIG. 14B is a sequence diagram illustrating a variation (Variation 2) of the first embodiment. When the captured image data is temporarily stored in step S1214, the browser unit 360 refers to the link setting information 101 (receipt.json) associated with the touch point ID. In the present variation, “enable: four-corners determination” is set to the item of “cognitive” of the link setting information 101. Accordingly, the browser unit 360 performs the four-corners determination processing (step S1420).

Subsequently, the browser unit 360 displays a preview image indicating a result of the four-corners determination processing (step S1421).

In the present variation, as a result of the four-corners determination processing, when the preview image does not include an image of the four corners of the receipts, the process proceeds to step S1422, which is described later, and when the preview image includes an image of the four corners of the receipts, the process proceeds to S1425.

When the preview image does not include the images of the four corners of the receipt as a result of the four-corners determination processing, the browser unit 360 receives an operation for capturing an image of the receipt again (step S1422). Subsequently, the browser unit 360 causes the camera function of the terminal device 300 to capture an image of the receipt (step S1423) to obtain image data, performs the four-corners determination processing on the image data, and displays a preview image of image obtained after the four-corners determination processing (step S1424).

The browser unit 360 may repeat the processing from step S1422 to step S1424 until the preview image includes an image of the four corners of the receipt.

When the preview image includes the image of the four corners of the receipt, the browser unit 360 receives an operation for submitting the submission item (step S1425), and uploads the image data obtained after the four-corners determination processing to the service link unit 250 along with the access token (step S1426).

Subsequently, the browser unit 360 displays a screen indicating that submission of the image data is completed (step S1427).

In addition, the service link unit 250 refers to the link setting information 101 associated with the touch point ID included in the access token received in step S1426 and performs the keystone correction processing (step S1428).

In Variation 2, since the character recognition processing (optical character recognition (OCR) processing) is set, the service link unit 250 performs the character recognition processing on the image data (step S1429). The character recognition processing may be performed when a character image is included in an image represented by the image data.

The processing performed by the information processing system 100 after step S1429 is substantially the same as the processing after step S1219 in FIG. 12A.

As described above, in Variation 2, the processing to be performed by the browser unit 360 and the processing to be performed by the service link unit 250 can be individually set. Accordingly, in Variation 2, the service link unit 250 can be set to perform processing having a high load, and the browser unit 360 can be set to perform processing having a relatively low load.

### Variation 3:

In Variation 3, when the image data of which an image of the receipt is captured is temporarily stored, the browser unit 360 reduces a size of the image data and uploads the reduced image data to the service link unit 250. Then, the service link unit 250 performs the four-corners determination processing as pre-processing on the reduced image data and causes the browser unit 360 to display a result of the four-corners determination processing.

Specifically, in Variation 3, the reduced image data is uploaded to the browser unit 360 by setting “reduction” to the item of “cognitive,” which is a setting item associated with the item of “capture” in the link setting information 101 (see FIGS. 9 and 10).

The value “reduction” set to the item of “cognitive” is a setting value for causing the service link unit 250 to perform the four-corners determination processing using reduced image data as pre-processing of the keystone correction processing and to perform the keystone correction processing in accordance with a result of the four-corners determination processing.

A process performed by the information processing system 100 according to Variation 3 is described below with reference to FIG. 14C.

FIG. 14C is a sequence diagram illustrating a variation (Variation 3) of the first embodiment. When the captured image data is temporarily stored in step S1214, the browser unit 360 refers to the link setting information 101 (receipt.json) associated with the touch point ID. In the present variation, “reduction” is set to the item of “cognitive” of the link setting information 101. Accordingly, the browser unit 360 generates reduced image data by reducing the image data temporarily stored and uploads the reduced image data to the service link unit 250 (step S1430).

When the reduced image data is uploaded, the service link unit 250 refers to the link setting information 101 associated with the touch point ID and performs the four-corners determination processing (step S1431).

The browser unit 360 makes an acquisition request to the service link unit 250 in order to acquire image data indicating a result of the four-corners determination processing (step S1432), and acquires the image data indicating the result of the four-corners determination processing (step S1433).

Subsequently, the browser unit 360 displays a preview image indicating the acquired result of the four-corners determination processing (step S1434).

In the present variation, as for a result of the four-corners determination processing, when the preview image does not include an image of the four corners of the receipt, the process proceeds to step S1435, and when the preview image includes an image of the four corners of the receipt, the process proceeds to step S1442, which is described later.

The browser unit 360 receives an operation of capturing an image of the receipt again (step S1435). Subsequently, the browser unit 360 causes the camera function of the terminal device 300 to capture an image of the receipt (step S1436).

Subsequently, the browser unit 360 generates reduced image data, and uploads the reduced image data to the service link unit 250 (step S1437). Since the processing from step S1437 to step S1441 in FIG. 14C is substantially the same as the processing from step S1430 to step S1434 in FIG. 14C, the description thereof is omitted.

As for a result of the four-corners determination processing, when the preview image includes the image of the four corners of the receipt, the browser unit 360 receives an operation for submitting the submission item (step S1442), and uploads the image data obtained after the four-corners determination processing to the service link unit 250 along with the access token (step S1443).

Since the processing from step S1442 to step S1446 in FIG. 14C is substantially the same as the processing from step S1425 to step S1429 in FIG. 14B, the description thereof is omitted.

The processing performed by the information processing system 100 after step S1446 is substantially the same as the processing after step S1219 in FIG. 12A.

As described above, in Variation 3, a result of the four-corners determination processing is displayed by the browser unit 360 before the keystone correction processing is performed by the service link unit 250. Accordingly, in Variation 3, whether the image has been appropriately captured or not can be notified to the user of the terminal device 300.

### Variation 4:

Variation 4 is one of variations of processing including the collection processing illustrated in step S1219 of FIG. 12A and subsequent processing. In Variation 4, in the collection processing, the image data before the recognition processing is performed is collected along with the image data after the recognition processing of the image data is performed. The image data before the recognition processing is performed is image data representing an image captured by the image capturing function of the terminal device 300. In the following description, image data before the recognition processing is performed may be referred to as original image data.

In Variation 4, a case in which a user who submits the image data and a user who collects the image data are the same is described. The user who submits the image data may be a user of the terminal device 300 and the PC browser 500.

In Variation 4, an item of “option” is added to the setting items associated with the item of “collect” (see FIGS. 9 and 10). At the item of “option,” information to be notified along with the URL set to the item of “webHook” is set. In other words, at the item of “option,” information to be notified along with the URL to which completion of submission of a submission item is to be notified is set.

Specifically, in Variation 4, “originalImage” is set to the item of “option,” which is a setting item associated with the item of “collect” in the link setting information 101. With this, a URL indicating a storage location of the original image data is transmitted to the terminal device 300 along with the URL to which completion of submission of the submission item is to be notified, in Variation 4.

A process performed by the information processing system 100 according to Variation 4 is described below with reference to FIG. 14D.

FIG. 14D is a sequence diagram illustrating a variation (Variation 4) of the first embodiment. In FIG. 14D, a user who submits a submission item and collects the submission item is referred to as a user A.

The processing 1219C in FIG. 14D is a variation of the collection processing in which the expense reimbursement service 450 collects the image data.

In FIG. 14D, the service link unit 250 identifies the link setting information 101 associated with the touch point ID, and notifies the URL, which is a notification destination, that the submission item has been submitted, based on the setting items of the identified link setting information 101 (step S1450).

In the present embodiment, regarding the setting related to collection of a submission item in the link setting information 101 (receipt.json) associated with the touch point ID, the URL is set to be notified that the submission item has been submitted. Accordingly, the service link unit 250 notifies to the URL, which is a notification destination, set in the link setting information 101, that the submission item has been submitted.

In addition, since “originalImage” is set to the item of “option” in the link setting information 101, the service link unit 250 additionally notifies the URL, which is a notification destination, of a URL indicating a storage location of the original image data.

Specifically, the notification includes a collection URL that is a URL indicating a storage location in which the submission item is temporarily stored, and the URL indicating a storage location of the original image data.

The image data as the submission item is image data obtained after the recognition processing is performed. In other words, the image data as the submission item is image data obtained after the recognition processing including the four-corners determination processing, the keystone correction processing, and the character recognition processing is performed. In the following description, the image data as the submission item may be referred to as corrected image data.

The expense reimbursement service 450 make an acquisition request to the collection URL in order to acquire the corrected image data (step S1451).

The service link unit 250 transmits the corrected image data stored in the configuration corresponding to the expense reimbursement service 450 to the expense reimbursement service 450 (step S1452).

Subsequently, the expense reimbursement service 450 make an acquisition request to the URL indicating a storage location of the original image data in order to acquire the original image data (step S1453).

The service link unit 250 transmits the original image data, which is temporarily stored, to the expense reimbursement service 450 (step S1454).

Subsequently, the expense reimbursement service 450 checks whether each of a file name of the corrected image data, which is received, and a file name of the original image data matches the user ID of the user who currently logs in to the expense reimbursement service 450, and when each of the file name and the user ID matches, transmits the corrected image data and the original image data to the PC browser 500 (step S1455).

The PC browser 500 displays a confirmation screen that is a screen for confirming the corrected image data and the original image data, which are collected (step S1456).

Specifically, the PC browser 500 may display the corrected image data and the original image data in the display area 132e of the screen 132A (see FIG. 13B).

Subsequently, in response to receiving an operation indicating that the user A has determined that the corrected image data is appropriate (step S1457), the PC browser 500 transmits a notification indicating that confirmation of the image data is completed, to the expense reimbursement service 450 (step S1458).

In the present variation, the case in which the corrected image data is determined to be appropriate is, for example, a case where a corrected image displayed on the confirmation screen includes the four corners of the receipt.

The expense reimbursement service 450 receives the notification and performs processing for expense reimbursement (step S1459).

When the user A determines that the corrected image data is inappropriate, the user A performs an operation for reading the QR code 132c displayed on the screen 132A of the PC browser 500 by the terminal device 300 in order to submit the submission item again (step S1460). In this case, the process performed by the information processing system 100 returns to step S1202 in FIG. 12A, and performs the processing after step S1202 (step S1461).

As described above, in Variation 4, the user who has submitted a submission item can check a state of the submission item, and when the submission item is not in an appropriate state, the user can submit a submission item again.

### Variation 5:

In Variation 5, when transmitting the collection URL to the expense reimbursement service 450. the service link unit 250 also transmits the URL indicating the storage location of the original image data and a URL indicating a destination for submitting a submission item again. In the following description, the URL indicating a destination for submitting a submission item again may be referred to as a URL for submitting again.

For example, in Variation 5, “originalImage” and “uploadURL” are set at the item of “option,” which is a setting item associated with the item of “collect” in the link setting information 101.

With this setting, when a user who submits the image data and a user who collects the image data are different from each other, another user who is different from the user who has submitted the image data can submit the submission item again.

A process performed by the information processing system 100 according to Variation 5 is described below with reference to FIG. 14E. In FIG. 14E, a user who submits a submission item is user A, and a user who collects the submission item is user B. In other words, the user A is a user of the browser unit 360, and the user B is a user of the PC browser 500.

FIG. 14E is a sequence diagram illustrating a variation (Variation 5) of the first embodiment. Processing 1219D in FIG. 14E is a variation of the collection processing in which the expense reimbursement service 450 collects the image data. In FIG. 14E, regarding to the same processing as that in FIG. 14D, the same step number is given as that used in FIG. 14D, and the description thereof is omitted.

In FIG. 14E, the service link unit 250 identifies the link setting information 101 associated with the touch point ID, and notifies the URL, which is a notification destination, that the submission item has been submitted, based on the setting items of the identified link setting information 101 (step S1450A).

At this time, since “originalImage” and “upload URL” are set to the item of “option” in the link setting information 101 associated with the touch point ID. the service link unit 250 notifies the URL, which is a notification destination, of a URL indicating a storage location of the original image data and a URL for submitting again.

In response to receiving the corrected image data and the original image data in step S1454, the expense reimbursement service 450 checks whether each of a file name of the corrected image data, which is received, and a file name of the original image data matches the user ID of the user who currently logs in to the expense reimbursement service 450, and when each of the file name and the user ID matches, transmits the corrected image data, the original image data, and the URL for submitting again to the PC browser 500 (step S1455A).

The PC browser 500 displays a confirmation screen that is a screen for confirming the corrected image data, the original image data, and the URL for submitting again, which are received (step S1456A). Specifically, the PC browser 500 may display the corrected image data, the original image data, and the URL for submitting again in the display area 132e of the screen 132A (see FIG. 13B).

Subsequently, when the corrected image data is determined to be appropriate by the user B, the PC browser 500 performs processing from step S1457 to step S1459.

When the corrected image data is determined to be inappropriate by the user B, the PC browser 500 receives an operation for requesting to acquire the original image data (step S1470). Then, the PC browser 500 outputs the original image data (step S1471).

When an image is edited by the user B (step S1472) and an operation for accessing the URL for submitting again displayed on the confirmation screen is received (step S1473), the PC browser 500 makes a connection request to the service link unit 250 (step S1474).

Editing the original image data may be performed on the PC browser 500 or another information processing apparatus.

In response to the connection request, the service link unit 250 transmits an instruction to display a screen for submitting the receipt again to the PC browser 500 (step S1475). In response to receiving the display instruction, the PC browser 500 displays the screen for submitting the receipt again (step S1476).

Subsequently, in response to receiving an operation for submitting the edited image data (edited submission item) again (step S1477), the PC browser 500 uploads the edited image data to the service link unit 250 along with the access token (step S1478).

Next, the service link unit 250 performs recognition processing on the image data based on the link setting information 101 associated with the touch point ID stored in the access token (step S1479).

Subsequently, the service link unit 250 notifies the URL, which is a notification destination, that the submission item has been submitted (step S1480). The notification includes the collection URL, the URL indicating a storage location of the original image data, and the URL for submitting again.

Processing after step S1480 is substantially the same as the processing after step S1225 illustrated in FIG. 12B.

As described above, in Variation 5, by notifying the PC browser 500 of the URL for submitting again, the user who collects the submission item can submit the submission item again on behalf of the user who has submitted the submission item.

### Variation 6:

Variation 6 is one of variations of processing including the collection processing illustrated in step S1219 of FIG. 12A and subsequent processing. In Variation 6, a mail address of a user who has submitted a submission item is notified to the URL. which is a notification destination.

Specifically, in Variation 6, “emailAddress” is set to the item of “option,” which is a setting item associated with the item of “collect” in the link setting information 101.

A process performed by the information processing system 100 according to Variation 6 is described below with reference to FIG. 14F. FIG. 14F is a sequence diagram illustrating a variation (Variation 6) of the first embodiment.

In FIG. 14F, a user who submits a submission item is user A. and a user who collects the submission item is user B. In other words, the user A is a user of the browser unit 360, and the user B is a user of the PC browser 500.

Processing 1219E in FIG. 14F is a variation of the collection processing in which the expense reimbursement service 450 collects the image data. In FIG. 14F, regarding to the same processing as that in FIG. 14D, the same step number is given as that used in FIG. 14D, and the description thereof is omitted.

In FIG. 14F, the service link unit 250 identifies the link setting information 101 associated with the touch point ID, and notifies the URL, which is a notification destination, that the submission item has been submitted, based on the setting items of the identified link setting information 101 (step S 1491).

At this time, since “emailAddress” is set to the item of “option” in the link setting information 101 associated with the touch point ID, the service link unit 250 notifies the URL, which is a notification destination, of an e-mail address of the user (user A) who has submitted the submission item.

The e-mail address of the user who has submitted the submission item may be stored in association with the user ID, in the user storage unit 290, for example.

The service link unit 250 may refer to the user storage unit 290, acquire an e-mail address corresponding to the user ID identified from the touch point ID, and notify the URL, which is a notification destination, of the e-mail address.

Since processing from step S1492 to step S1494 in FIG. 14F is substantially the same as the processing from step S1224 to step S1226 in FIG. 12B, a description thereof is omitted.

Subsequent to step S1494, the PC browser 500 displays a confirmation screen that is a screen for confirming the corrected image data, which is collected (step S1495). The e-mail address of the user who has submitted the submission item is displayed on the confirmation screen.

In Variation 6, when the submitted image data is determined to be inappropriate by the user B, the PC browser 500 receives an e-mail transmission request for transmitting an e-mail indicating requesting the user A to submit the submission item again (step S1496). In response to the request, the PC browser 500 transmits a request mail for requesting to submit the submission item again to the e-mail address of the user A (step S1497).

When the terminal device 300 receives a user operation performed by the user A for reading the QR code 132c displayed on the screen 132A of the PC browser 500 in order to submit the submission item again (step S1498), the process performed by the information processing system 100 returns to step S1202 in FIG. 12A and performs the processing of step S1202 and the subsequent steps (step S1499).

As described above, in Variation 6, the user who has submitted the submission item can be requested to submit the submission item again.

In Variation 6. the e-mail address of the user who has submitted the submission item is used as information for identifying the terminal device 300 used by the user who has submitted the submission item, but the information is not limited thereto. In Variation 6, the information for identifying the terminal device 300 used by the user who has submitted the submission item may be information other than the e-mail address. Specifically, for example, in a case where the terminal device 300 is a smartphone, a phone number of the terminal device 300 may be used.

### Second Embodiment

A second embodiment is described below with reference to the drawings. The second embodiment is different from the first embodiment in that the external service is an external service using a face photo. Therefore, in the following description of the second embodiment, differences from the first embodiment are described. In the following description of the second embodiment, the same reference numerals are given to the same or corresponding functions or configurations as those of the first embodiment, and redundant descriptions thereof are omitted or simplified appropriately.

FIG. 15 is a diagram illustrating an example of link setting information according to the second embodiment. Link setting information 101A illustrated in FIG. 15 is an example of the link setting information set by the external server 400 in a case that the external services provided by the external server 400 is a student ID card issuing service.

The student ID card issuing service is, for example, a service for issuing a student ID card by using a face photo submitted by a student. A file name of the link setting information 101A is, for example, “card.json.”

In the link setting information 101A illustrated in FIG. 15, as settings related to a QR code, “oauth authentication” is set to the item of “oauthType,” and a period from Mar. 1, 2022 to Apr. 30, 2022, as a valid period, is set to the item of “time.”

In addition, a character string “Postcard” is set to the item of “eID.” The character string “Postcard” indicates, for example, that an application is based on a QR code printed on a postcard.

In addition, in the link setting information 101A, as settings related to a submission item, a resolution of image data is set to “high definition” at the item of “resolution,” and an aspect ratio of the image data is set to 3:4 to the item of “aspect.” In addition, in the link setting information 101A, a single piece of image data is set to the item of “number” as a setting related to a submission item. To the item of “target,” “face” is set. To the item of “cognitive,” “enable” is set. In the present embodiment, processing for removing the background of the face photo and in a case that the object is not a face photo, instructing to capture an image again are set to the recognition processing to be performed with respect to the image capturing object (submission item).

In addition, in the link setting information 101A, as a setting related to a screen of the terminal device 300 in submitting a submission item, “Apply for Student ID Card” as a title of the screen is set to the item of “title.” To the item of “elements,” two arrays are set.

Specifically, in the first array, “message” is set to the item of “type,” and “Please take your face photo.” is set to the item of “name.” In other words, in the link setting information 101A, a message of “Please take your face photo.” is displayed on the screen of the terminal device 300.

In the second array, “text” is set to the item of “type,” and “Please register your phone number.” is set to the item of “name.” In other words, in the link setting information 101A, “Please register your phone number.” and an input field for an answer are displayed on the screen of the terminal device 300.

In addition, in the link setting information 101A, as settings related to collection of a submission item, jpeg data is set to the item of “format,” and a file name of the submission item is set to “%UseID” at the item of “fname.” In other words, in the link setting information 101A, a file name of the submission item is a user ID in the student ID card issuing service.

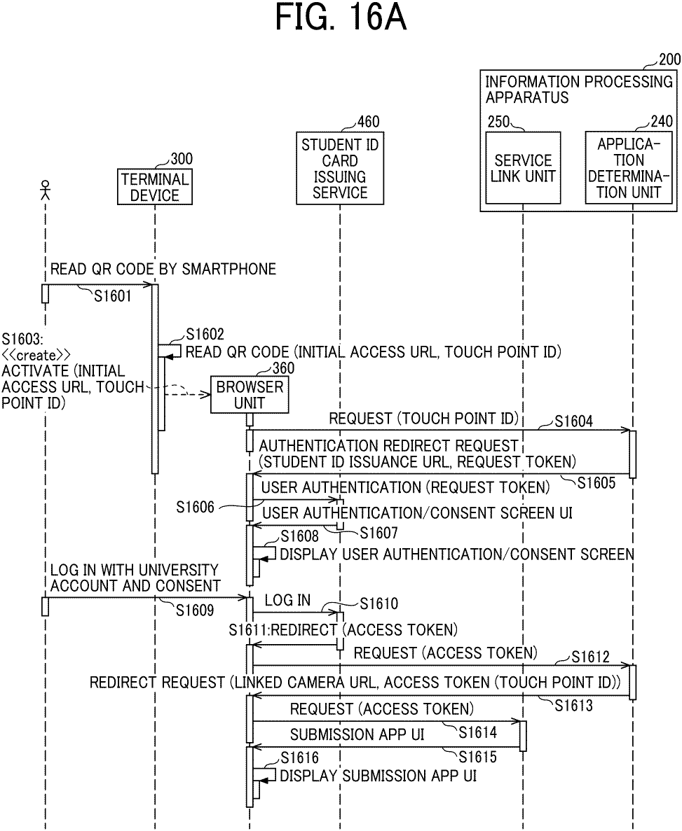

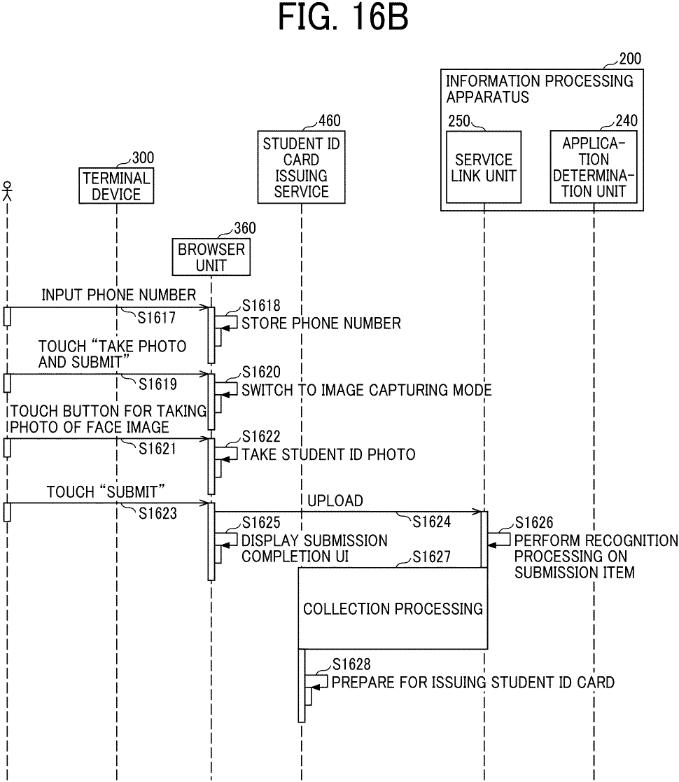

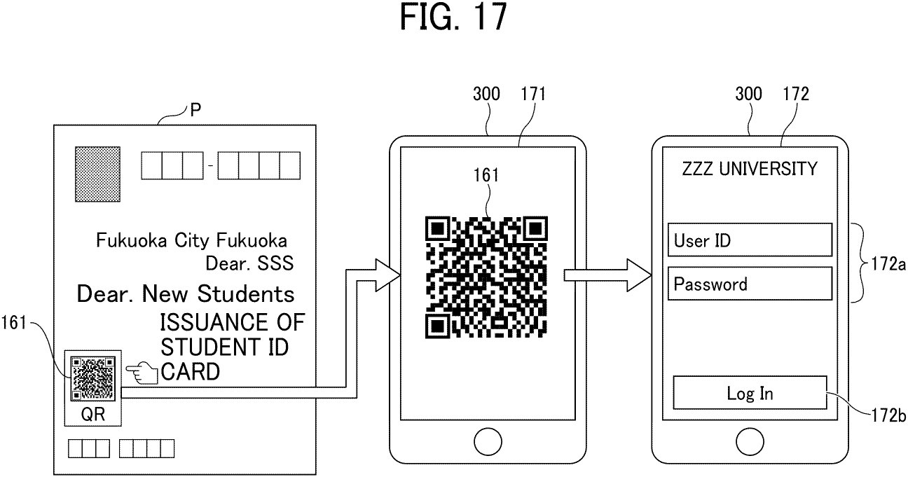

A process performed by the information processing system 100 according to the present embodiment is described below with reference to FIGS. 16A and 16B. FIGS. 16A and 16B are sequence diagrams each illustrating a process performed by the information processing system 100 according to the second embodiment.

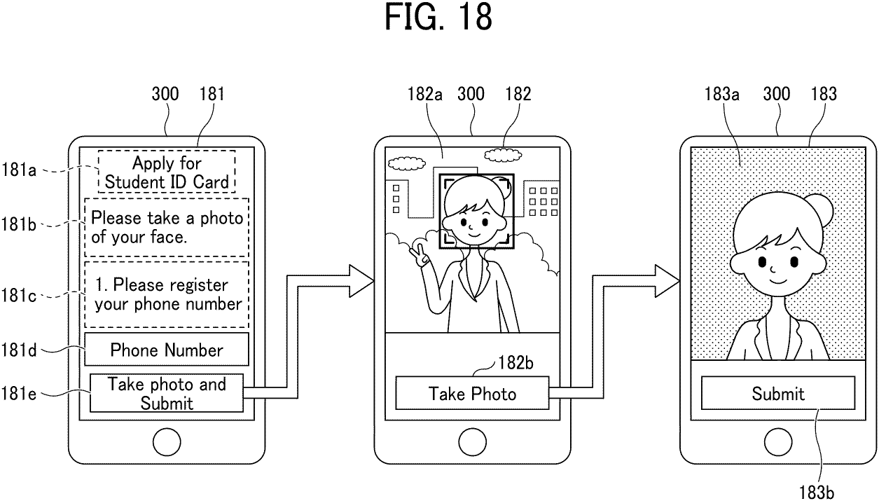

In the present embodiment, a postcard P on which a QR code 161 acquired from the service link unit 250 is printed is distributed to a new student who is to apply for issuance of a student ID card. An example of the postcard P is illustrated in FIG. 17. The student ID card issuing service 460 provides a service for issuing a student ID card by using a face photo submitted by a new student who is a user of the terminal device 300 that reads the QR code 161.

In the present embodiment, processing until the student ID card issuing service 460 transmits an API key to the service link unit 250 and acquires a QR code is substantially the same as the processing illustrated in FIG. 11, except for that the API key is “apikey2,” and a file name of the link setting information 101A is “card.json.” Accordingly, the description thereof is omitted in the present embodiment.

In the present embodiment, the touch point ID included in the QR code 161 is “tp002.” Accordingly, in the present embodiment, when the QR code 161 is acquired, the touch point ID “tp002,” “card.json,” and tenant ID “tid200” corresponding to “apikey2” are stored in association with each other in the link management storage unit 280.

In the information processing system 100, the terminal device 300 receives an operation for reading the QR code 161 printed on the postcard P (step S1601), and reads the QR code (step S1602). The operation for reading the QR code is, for example, a user operation of holding the terminal device 300 over the QR code displayed on a submission screen.

Upon reading the QR code, the terminal device 300 activates the browser unit 360 (step S1603).

In response to the activation, the browser unit 360 makes a connection request to an initial access URL (application determination unit 240) read from the QR code (step S1604). The connection request includes a touch point ID acquired from the QR code.

The application determination unit 240 of the information processing apparatus 200 transmits a redirect request to the browser unit 360 (step S1605).

In this example, OAuth is set to the authentication method that is a setting item associated with the QR code of the link setting information 101A (card.json) associated with the touch point ID. Accordingly, the application determination unit 240 refers to the setting items associated with the QR code of the link setting information 101A (card.json) identified from the link management storage unit 280, and transmits a redirect request to the student ID card issuing service 460 along with a request token. In this example, it is assumed that the student ID card issuing service 460 includes an authentication service.

In response to receiving the redirect request, the browser unit 360 makes an authentication request to the student ID card issuing service 460 (step S1606).

In response to the authentication request, the student ID card issuing service 460 transmits, to the browser unit 360. user authentication and an instruction to display a screen for confirming whether a consent in relation to giving permission to the service link unit 250 to access personal information is present (step S1607).

The browser unit 360 displays a screen for user authentication and confirmation for whether the consent in relation to giving permission to access personal information is present (step S1608).

In step S1609, the browser unit 360 receives an input of account information used for user authentication according to an operation performed by the user of the terminal device 300 and receives an operation indicating the consent in relation to giving permission to access the personal information. The account information input at this time is account information for logging in to the student ID card issuing service 460, and includes a user ID and a password. In the present embodiment, the user ID of the user is “SSS.”

In response to receiving the operation, the browser unit 360 makes an authentication request to the student ID card issuing service 460 (step S1610).

The student ID card issuing service 460 performs authentication and transmits a redirect request to the browser unit 360, which is an authentication request source, along with an access token (step S1611).

In response to receiving the redirect request, the browser unit 360 makes a request to the application determination unit 240 (step S1612).

In response to receiving the request, the application determination unit 240 makes a redirect request to the browser unit 360 (step S1613). The redirect request includes the URL of the service link unit 250 and the access token. The access token includes a touch point ID included in the QR code.

In response to receiving the redirect request, the browser unit 360 makes a connection request to the service link unit 250 (step S1614).

In response to receiving the connection request, the service link unit 250 identifies, from the link management storage unit 280, the link setting information 101A (card.json) that is associated with the touch point ID of “tp002” in the link management storage unit 280 and refers to the settings related to a guide screen for causing the terminal device 300 to output image data corresponding to the external service of the identified link setting information 101A (card.json).

Then, the service link unit 250 responds, to the browser unit 360, with a character string indicating a title of a screen to be displayed on the terminal device 300, display components to be displayed on the screen, a format of the display components to be displayed on the screen, and a character string indicating content of display items to be displayed on the screen, as information for displaying a face photo submission screen that is a screen for submitting a face photo (step S1615). Based on the information, the browser unit 360 displays the face photo submission screen (step S1616).

As described above, by transmitting the link setting information 101A associated with the touch point ID to the terminal device 300, the settings related to a guide screen identified by the link setting information 101A can be reflected by settings for processing for implementing the service to be executed by the terminal device.

On the face photo submission screen displayed, a message instructing to take a photo of face, a message instructing to input a phone number, and an input field for inputting a phone number are displayed.

In response to receiving an input operation for a phone number (step S1617), the browser unit 360 temporarily stores the input telephone number (step S1618).

Subsequently, in response to receiving an operation for starting submission of a face photo (step S1619), the browser unit 360 switches the mode of the terminal device 300 to the image capturing mode (step S1620).

Subsequently, in response to receiving an operation for taking a photo corresponding to a face of the user (step S1621), the browser unit 360 cause the camera to capture an image corresponding to the face to obtain image data corresponding to a face photo (step S1622).

Subsequently, in response to receiving an operation for submitting the face photo (step S1623), the browser unit 360 uploads the captured image data and a response file to the service link unit 250 along with the access token (step S1624).

The response file is a file in which the phone number input as an answer to the message in step S1617 is described in a JSON format.

Subsequently, the browser unit 360 displays a screen indicating that the submission of the image corresponding to the face is completed, and then ends the display (step S1625).

In addition, the service link unit 250 identifies the link setting information 101A (card.json) associated with the touch point ID stored in the access token from the link management storage unit 280, and performs the recognition processing on the image data based on the settings related to a submission item and the collection of the identified link setting information 101A (card.json) (step S1626).

For example, the service link unit 250 stores a file name of the uploaded image data as “SSS.jpeg,” which is the user ID of the user, based on the settings related to collection of a submission item in the link setting information 101A (card.json). In addition, the service link unit 250 performs recognition processing including removing the background of the face photo based on the settings related to a submission item in the link setting information 101A (card.json), and in a case that the recognition processing result is determining that the photo is not a face phot, performs processing for notifying the terminal device 300 of an instruction to capture an image again.

Subsequently, the service link unit 250 performs the collection processing of causing the student ID card issuing service 460 to collect the image data having a configuration corresponding to the student ID card issuing service 460 based on the settings related to collection of a submission item in the identified link setting information 101A (card.json) (step S1628). Since the collection processing is substantially the same as that in the first embodiment, the description thereof is omitted.

After collecting the submission item, the student ID card issuing service 460 prepares to issue a student ID card (step S1629).

Screen transition of the browser unit 360 according to the present embodiment is described below with reference to FIGS. 17 and 18 FIG. 17 is a diagram illustrating an example of a screen transition according to the second embodiment.

In the present embodiment, the postcard P on which the QR code 161 acquired by the student ID card issuing service 460 from the service link unit 250 is attached may be mailed to an address of each new student. A new student is the user of the terminal device 300 and a user of the student ID card issuing service 460.

When the terminal device 300 is held over the QR code 161 attached to the postcard P, the terminal device 300 displays a screen 171. Then, when the terminal device 300 reads the QR code 161, the screen 171 transitions to a screen 172 according to card.json associated with the touch point ID included in the QR code 161.

The screen 172 is an example of a screen for performing user authentication and confirmation for whether the consent in relation to giving permission to access personal information is present, and is displayed by the browser unit 360 in step S1608 in FIG. 16A.

The screen 172 includes an input field 172a and an operation button 172b. In the input field 172a, account information of a user (new student) to log in to the student ID card issuing service 460 is input.

The operation button 172b is an operation button for requesting the student ID card issuing service 460 to perform authentication. Operating the operation button 172b also indicates the consent in relation to giving permission to the service link unit 250 to access personal information. In the present embodiment, when the operation button 172b is operated on the screen 172, an authentication request is transmitted to the student ID card issuing service 460, and when the authentication is successful, the screen 172 transitions to a screen 181, which is described later.

FIG. 18 is a diagram illustrating an example of a screen transition according to the second embodiment. The screen 181 illustrated in FIG. 18 is an example of the face photo submission screen, and is displayed by the browser unit 360 in step S1616 of FIG. 16A.

The screen 181 includes display areas 181a, 181b, 181c. an input field 181d, and an operation button 181e.

In the display area 181a, a screen title of “Apply for Student ID Card,” which is set to the item of “title” in card.json is displayed.

In the display area 181a, a first array set to the item of “elements” in card.json is displayed. Specifically, in the display area 181b. a message such as “Please take photo of your face.” is displayed. An input field for inputting an answer to the message is not displayed.

In the display area 181c, a second array set to the item of “elements” in card.json is displayed. For example, in the display area 181c, a message such as “Please register your phone number.” is displayed. In addition, the input field 181d is displayed as an input field for an answer to the message.

The operation button 181e is an operation button for switching the terminal device 300 to the image capturing mode.

In the present embodiment, when a phone number is input to the input field 181d and the operation button 181e is operated, the screen 181 transitions to a screen 182.

The screen 182 illustrates an example of a screen displayed when the terminal device 300 is in the image capturing mode. The screen 182 includes a display area 182a and an operation button 182b. An image to be captured by the camera of the terminal device 300 is displayed in the display area 182a. The operation button 182b is an operation button for capturing image data displayed in the display area 182a.

When the operation button 182b is operated on the screen 182, the terminal device 300 captures an image in the display area 182a and causes the browser unit 360 to display a screen 183. On the screen 182, an image of face image of the new student is displayed in the display area 182a, and when the operation button 182b is operated, the image of face image is captured.

The screen 183 is an example of a screen for uploading the captured image data to the service link unit 250. The screen 183 includes a display area 183a and an operation button 183b. The captured face image is displayed in the display area 183a.

The operation button 183b is an operation button for uploading (transmitting) the image data displayed in the display area 183a to the service link unit 250. In other words, the operation button 183b is an operation button for causing the service link unit 250 to submit the image data of the face image.

In the present embodiment, the face image displayed in the display area 183a is an image obtained after the background is removed.

In this case, when the operation button 182b is selected on the screen 182 and an image is captured to obtain image data, the browser unit 360 transmits the captured image data to the service link unit 250. Then, the browser unit 360 may acquire, from the service link unit 250, image data that is obtained after the recognition processing is performed on the image capturing object, and display the acquired image data in the display area 183a of the screen 183 as an image to be submitted. In the present embodiment, the browser unit 360 may perform the recognition processing on the image capturing object and display the result in the display area 183a.

When the operation button 183b is operated on the screen 183, the browser unit 360 uploads the image data of the face image to the service link unit 250.

As described above, in the present embodiment, whether to receive input of an answer to a message on the screen displayed by the browser unit 360 can be set, and data having the configuration corresponding to the student ID card issuing service 460 can be submitted.

### Third Embodiment

A third embodiment is described below with reference to the drawings. The third embodiment is different from the first embodiment in that an external service manages inventory of products and uses image data of an image obtained by capturing an image of a product. Therefore, in the following description of the third embodiment, differences from the first embodiment are described. In the following description of the third embodiment, the same reference numerals are given to the same or corresponding functions or configurations as those of the first embodiment, and redundant descriptions thereof are omitted or simplified appropriately.

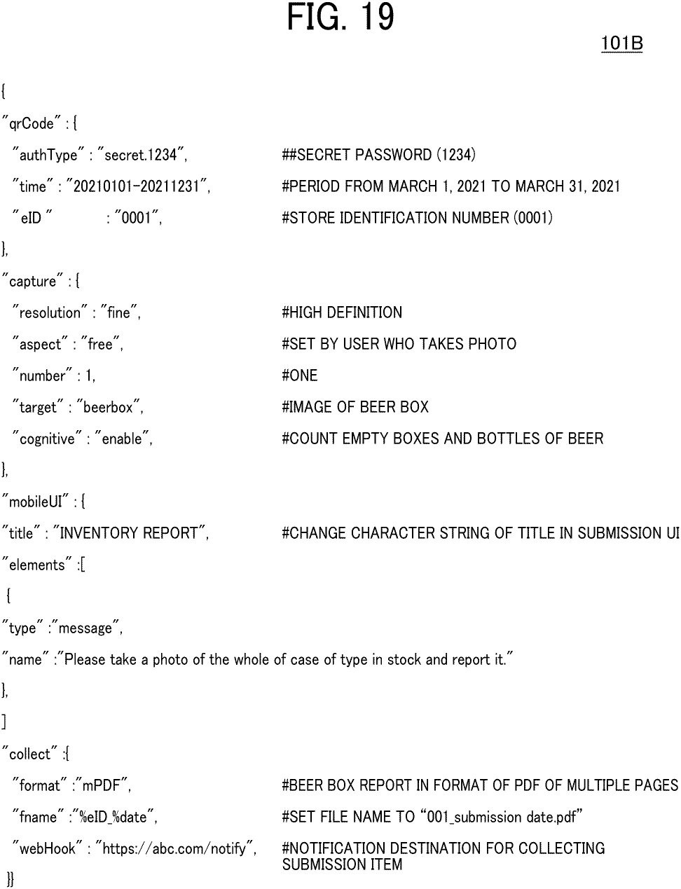

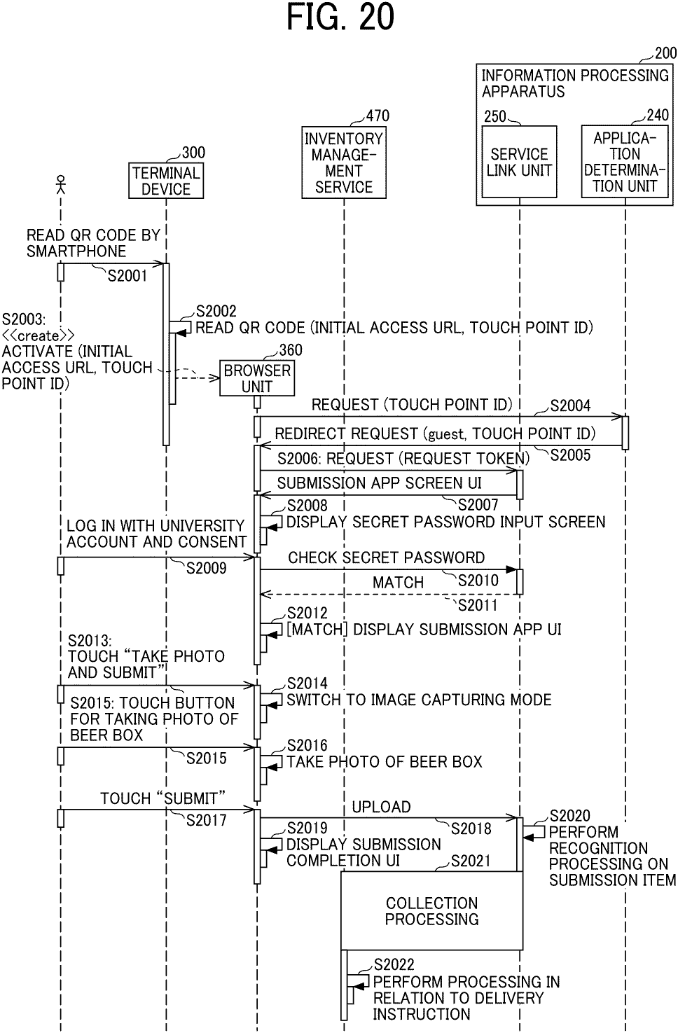

FIG. 19 is a diagram illustrating an example of link setting information according to the third embodiment. Link setting information 101B illustrated in FIG. 19 is an example of the link setting information set by the external server 400 in a case that the external services provided by the external server 400 is an inventory management service.

The inventory management service is a service for obtaining the number of products from an image obtained by capturing an image of products and instructing delivery of products according to the inventory of the products, for example. In the present embodiment, bottled beer is described as an example of a product. A file name of the link setting information 101B is, for example, “beer.json.”

In the link setting information 101B illustrated in FIG. 19, “secret. 1234” is set to the item of “oauthType” as the settings related to a QR code. In other words, in the link setting information 101B, secret password authentication in which a secret password is “1234” is set as an authentication method.

A period from Mar. 1, 2021, to Mar. 31, 2021. as a valid period, is set to the item of “time.” In addition, a character string, “0001” indicating a store identification number, is set to the item of “eID.”

In addition, in the link setting information 101B, as settings related to a submission item, a resolution of image data is set to “high definition” at the item of “resolution,” and “free” is set to the item of “aspect.” Accordingly, in the present embodiment, the aspect ratio of image data is set by a user who takes a photo.

In addition, in the link setting information 101B, a single piece of image data, namely, one, is set to the item of “number” as a setting related to a submission item. To the item of “target,” “beerbox” is set. To the item of “cognitive,” “enable” is set. In the present embodiment, processing including determining the number of empty boxes and determining the number of bottles of bottled beer is performed as the recognition processing with respect to the image capturing object (submission item).

In addition, in the link setting information 101B, “mPDF” is set to the item of “format” as a setting related to collection of a submission item and defined as PDF data of multiple pages of images of beer box. In addition, “%eID_%date” is set to the item of “fname.” In other words, in the link setting information 101B, the store identification information and the date on which a submission item is submitted are included in a file name of a PDF file of multiple pages.

In addition, in the link setting information 101B, as a setting related to a screen of the terminal device 300 in submitting a submission item, “inventory Report” as a title of the screen may be set to the item of “title.” for example. In addition, in the link setting information 101B, in the item of “elements,” the item of “type” may be set to “message,” and the item of “name” may be set to “Please take a photo of the whole of a case of type in stoke and report it.”

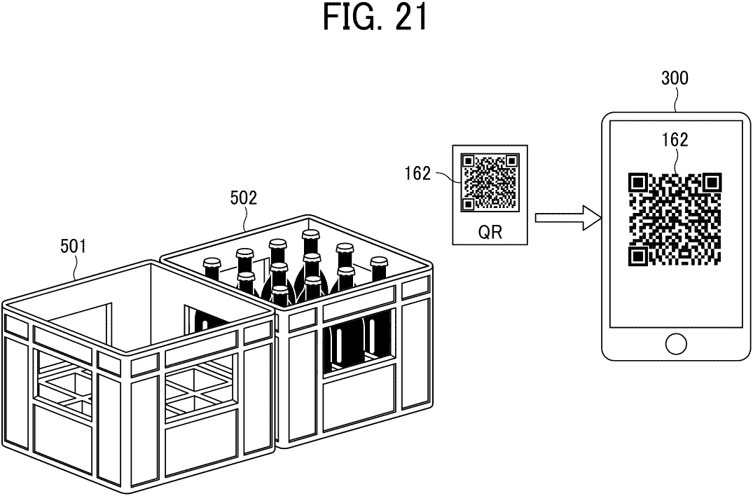

A process performed by the information processing system 100 according to the present embodiment is described below with reference to FIG. 20. FIG. 20 is a sequence diagram illustrating a process performed by the information processing system 100 according to the third embodiment.

In the present embodiment, a QR code 162 acquired from the service link unit 250 may be attached to, for example, a storage place where products (beer boxes) are stored in the store. The inventory management service 470 according to the present embodiment performs inventory management using an image of a product submitted by, for example, a staff member who reads the QR code 162 with the terminal device 300.

In the present embodiment, processing until the inventory management service 470 transmits an API key to the service link unit 250 and acquires a QR code is substantially the same as the processing illustrated in FIG. 11, except for that the API key is “apikey3,” and a file name of the link setting information 101 A is “beer.json.” Accordingly, the description thereof is omitted in the present embodiment. In the present embodiment, the touch point ID included in the QR code 162 is “tp003.”

Accordingly, in the present embodiment, when the QR code 162 is acquired, the touch point ID “tp003,” “beer.json,” and tenant ID “tid300” corresponding to “apikey3” are stored in association with each other in the link management storage unit 280.

Processing of S2001 to S2004 illustrated in FIG. 20 is substantially the same as the processing of S1601 to S1604 illustrated in FIG. 16A,except for that a QR code read by the terminal device 300 is the QR code 162 provided in a storage place of the products, and the description thereof is omitted, accordingly.

The application determination unit 240 of the information processing apparatus 200 transmits a redirect request in response to a request from the browser unit 360 (step S2005). The redirect request includes a URL of the service link unit 250 and an access token.

In this example, secret password authentication is set to the authentication method that is a setting item associated with the QR code of the link setting information 101B (beer.json) associated with the touch point ID. Accordingly, the application determination unit 240 refers to the setting items associated with the QR code of the link setting information 101B (beer.json), and the guest ID of “guest2” and the touch point ID of “tp003” are included in the access token.

In response to receiving the redirect request, the browser unit 360 makes a connection request to the service link unit 250 (step S2006).

In response to receiving the connection request, the service link unit 250 identifies the link setting information 101B (beer.json) associated with the touch point ID of “tp003” in the link management storage unit 280, refers to the setting items associated with the QR code of the identified link setting information 101B (beer.json), and responds to the browser unit 360 with information related to input of a secret password (step S2007).

Based on the information, the browser unit 360 displays a secret password input screen (step S2008).

In response to receiving the input of the secret password (step S2009), the browser unit 360 requests the service link unit 250 to determine whether the input secret password is correct or not (step S2010).

The service link unit 250 refers to the corresponding setting item associated with the QR code of the identified link setting information 101B (beer.json) to determine whether the input secret password matches the set secret password, and instructs the browser unit 360 to display a product image submission screen that is a screen for submitting an image of product when the input secret password matches the set secret password (step S2011).

In response to receiving the display instruction, the browser unit 360 refers to the setting items related to a guide screen for outputting image data corresponding to the external service to the terminal device 300 in the link setting information 101B (beer.json), and displays the product image submission screen (step S2012). After that, the process proceeds to step S2013.

Processing of S2013 to S2019 illustrated in FIG. 20 is substantially the same as the processing of S1619 to S1625 illustrated in FIG. 16B except for that the image capturing object is a beer box, and the description thereof is omitted, accordingly.

In addition, the service link unit 250 identifies the link setting information 101B (beer.json) associated with the touch point ID stored in the access token from the link management storage unit 280, and performs the recognition processing on image data based on the settings related to a submission item and the collection of the identified link setting information 101B (beer.json) (step S2020).

For example, the service link unit 250 stores the uploaded image data so as to set a file name of the uploaded image data to “001_211231.PDF,” which is a combination of a store identification number and a date on which the image is submitted, based on the settings related to collection of a submission item in the link setting information 101B (beer.json). In addition, the service link unit 250 performs processing including determining the number of empty boxes and determining the number of bottles of bottled beer as the recognition processing with respect to the image capturing object based on the setting related to a submission item in the link setting information 101B (beer.json).

Subsequently, the service link unit 250 performs the collection processing of causing the inventory management service 470 to collect the image data having a configuration corresponding to the inventory management service 470 based on the settings related to collection in the identified link setting information 101B (beer.json) (step S2021). Since the collection processing is substantially the same as that in the first embodiment, the description thereof is omitted.

When the submission item is collected, the inventory management service 470 performs processing for instructing delivery based on the inventory (step S2022).

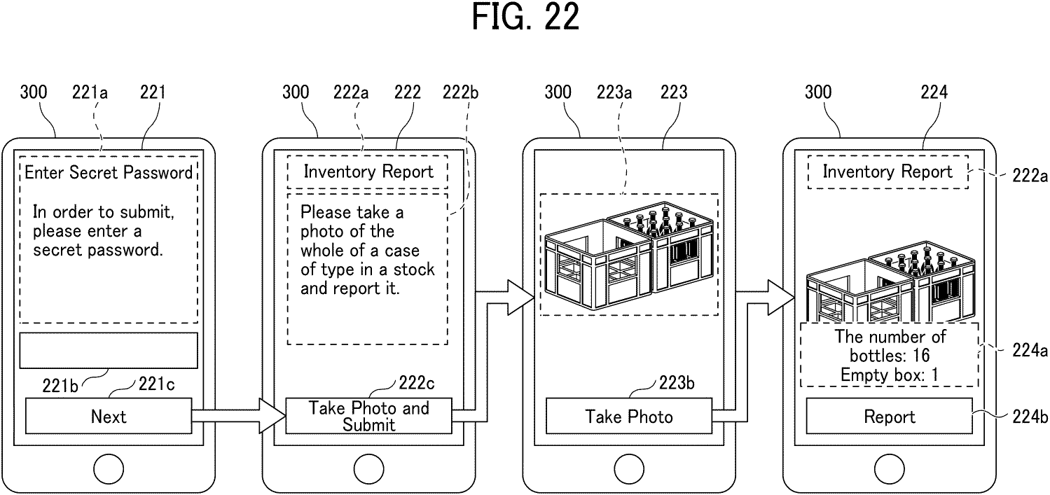

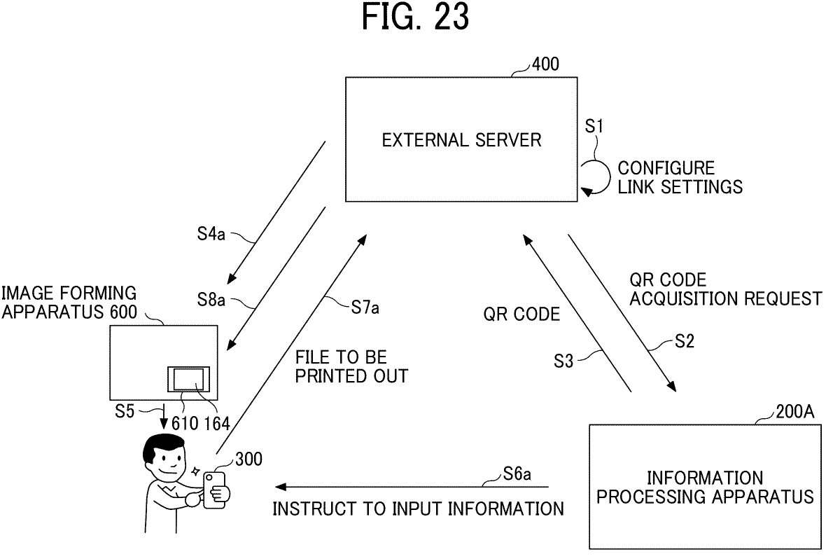

Screen transition of the browser unit 360 according to the present embodiment is described below with reference to FIGS. 21 and 22 FIG. 21 is a diagram illustrating an example of a screen transition according to the third embodiment.

FIG. 21 illustrates a state in which the terminal device 300 is held over the QR code 162. The QR code 162 is provided in, for example, a storage place of beer boxes 501 and 502 of which the inventory is managed by the inventory management service 470.

With respect to the terminal device 300, when the QR code 162 is read, the screen of the terminal device 300 transitions to a screen 221, which is described later.

FIG. 22 is a diagram illustrating an example of a screen transition according to the third embodiment. The screen 221 illustrated in FIG. 22 is an example of a secret password input screen that is a screen for inputting a secret password. The screen 221 is displayed after the terminal device 300 reads the QR code 162, and is displayed by the browser unit 360 in step S2008 of FIG. 20.

The screen 221 includes a display area 221a, an input field 221b, and an operation button 221c. In the display area 221a, a message instructing input of a set secret password is displayed. The input field 221b is an input field for inputting a secret password. The operation button 221c is an operation button for transmitting the secret password to the service link unit 250.

In the screen 221, when a secret password is input to the input field 221b, the operation button 221c is operated, and the input secret password matches the set secret password, the screen 221 transitions to a screen 222.

The screen 222 is an example of the product image submission screen, and is displayed by the browser unit 360 in step S2012 of FIG. 20. The screen 222 includes display areas 222a and 222b and an operation button 222c.

In the display area 222a, a screen title of “Inventory Report” set to a setting related to a guide screen for outputting image data corresponding to the external service to the terminal device 300 of the link setting information 101B (beer.json) is displayed. In the display area 222b, a massage of “Please take a photo of the whole of a case of type in a stock and report it.” set to a setting related to a guide screen for outputting image data corresponding to the external service to the terminal device 300 of the link setting information 101B (beer.json) is displayed. The operation button 222c is an operation button for switching the terminal device 300 to the image capturing mode.

As described above, by transmitting the link setting information 101B associated with the touch point ID to the terminal device 300, the settings related to a guide screen identified by the link setting information 101B can be reflected by settings for processing for implementing the service to be executed by the terminal device.

The screen 222 transitions to a screen 223 when the operation button 222c is operated and the terminal device 300 is switched to the image capturing mode.

The screen 223 illustrates an example of a screen when the terminal device 300 is in the image capturing mode. The screen 223 includes a display area 223a and an operation button 223b. An image to be captured by the camera of the terminal device 300 is displayed in the display area 223a The operation button 223b is an operation button for capturing image data displayed in the display area 223a.

When the operation button 223b is operated on the screen 223, the terminal device 300 captures an image in the display area 223a and causes the browser unit 360 to display a screen 224.

The screen 224 includes display areas 222a and 224a and an operation button 224b. In the display area 224a, the number of bottles of beer and the number of empty boxes obtained as a result of the recognition processing with respect to the image capturing object are displayed. The operation button 224b is used to submit the captured image data to the service link unit 250.

As illustrated in the screen 224, also in the present embodiment, the service link unit 250 may perform the recognition processing with respect to the image capturing object, namely the captured image data, and display a result of the recognition processing on the browser unit 360.

When the operation button 224b is operated on the screen 223, the browser unit 360 uploads the image data representing the image captured on the screen 224 to the service link unit 250.

In the present embodiment, as described above, a screen for inputting a secret password before displaying the product image submission screen can be displayed according to the setting related to the authentication method in the link setting information. In other words, in the present embodiment, a screen to be displayed on the terminal device 300 can be changed according to the settings related to the authentication method in the link setting information.

### Fourth Embodiment

A fourth embodiment is described below with reference to the drawings. The fourth embodiment is different from the first embodiment in that the service link unit 250 manages an application associated with a QR code. Therefore, in the following description of the fourth embodiment, differences from the first embodiment are described. In the following description of the fourth embodiment, the same reference numerals are given to the same or corresponding functions or configurations as those of the first embodiment, and redundant descriptions thereof are omitted or simplified appropriately.

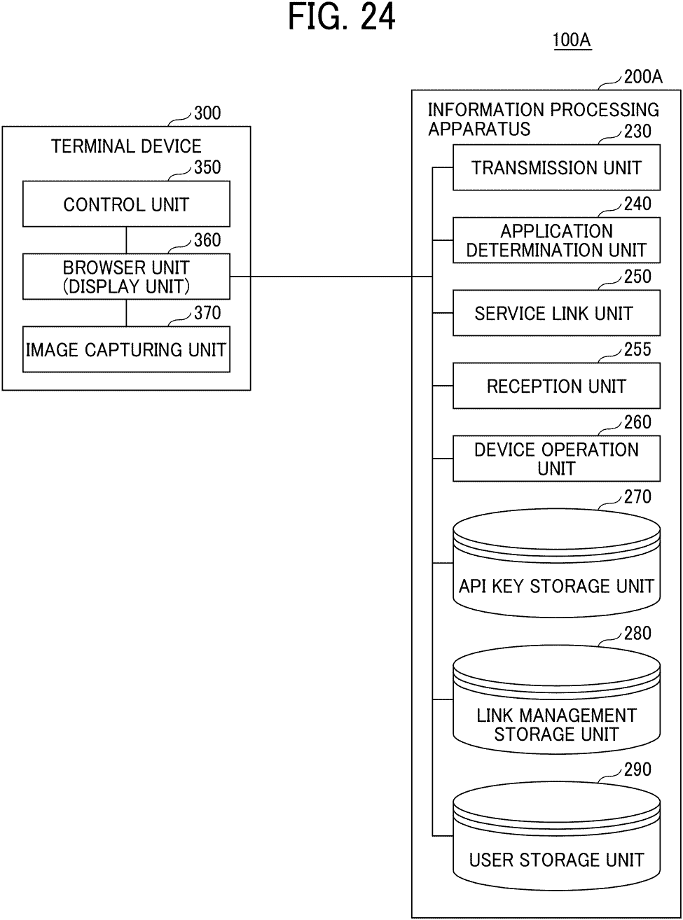

FIG. 23 is an illustration for describing an overview of a process performed by an information processing system 100A according to the fourth embodiment of the present disclosure. An information processing apparatus 200A according to the present embodiment manages a web application associated with a QR code by the service link unit 250. In the present embodiment, the web application managed by the service link unit 250 is described as a dedicated application for operating an image forming apparatus 600. The image forming apparatus 600 includes, for example, a Multifunction Peripheral (MFP).

The processing of steps S1 to S3 of FIG. 23 is substantially the same as the processing of steps S1 to S3 of FIG. 2. In other words, a method of providing the QR code 164 to the external server 400 by the information processing apparatus 200A of the present embodiment is substantially the same as that of the first embodiment.

The external server 400 according to the present embodiment may provide an external service that uses the image forming apparatus 600.

Upon acquiring the QR code, the external server 400 causes a display 610 of the image forming apparatus 600 to display the QR code 164 (step S4a).

With respect to the terminal device 300, when a user of the external service operates to read the QR code 164 displayed by the display 610 (step S5), the information processing apparatus 200A is notified that the QR code 164 has been read.

In response to the notification, the information processing apparatus 200A uses the dedicated application for operating the image forming apparatus 600 to instruct the terminal device 300 to input information for operating the image forming apparatus 600 (step S6a).

When various information is input to the terminal device 300, the terminal device 300 transmits a file to be printed by the image forming apparatus 600 to the external server 400 (step S7a). In response to receiving the file to be printed from the terminal device 300, the external server 400 instructs the image forming apparatus 600 to output the file to be printed (step S8a).

In the present embodiment, by performing the process as described above, the user of the terminal device 300 can operate the image forming apparatus 600 installed in a convenience store, a drug store, or the like with his or her own terminal device 300. In other words, the image forming apparatus 600 can be caused to print out data stored in the terminal device 300 or data that can be acquired by the terminal device 300.

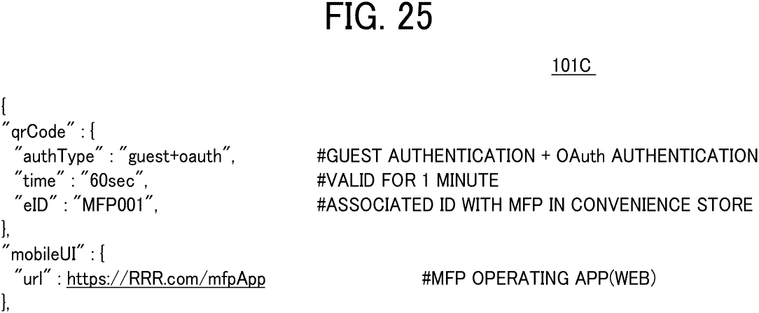

A functional configuration of the information processing apparatus 200A according to the present embodiment is described below with reference to FIG. 24. FIG. 24 is a block diagram illustrating a functional configuration of the information processing apparatus 200A and the terminal device 300 according to the fourth embodiment.

The information processing apparatus 200A according to the present embodiment includes a transmission unit 230, an application determination unit 240, a service link unit 250, a reception unit 255, and a device operation unit 260. Each of the functional units is implemented by the CPU 201 reading and executing the program.

The device operation unit 260 according to the present embodiment is one of the applications included in the information processing apparatus 200A. Specifically, the device operation unit 260 is a web application for the terminal device 300 that implements a service for operating the image forming apparatus 600. More specifically, the device operation unit 260 is a dedicated application for causing the browser unit 360 to display a screen for operating the image forming apparatus 600 installed in, for example, a store.

In the example of FIG. 24, the device operation unit 260 is included in the information processing apparatus 200A, but is not limited thereto. The device operation unit 260 may be provided in an external device of the information processing apparatus 200A.

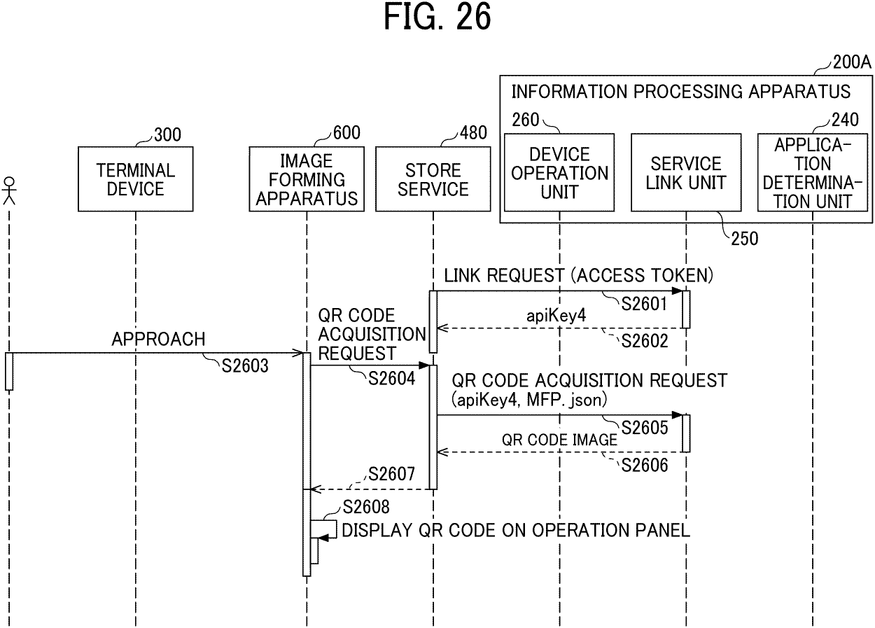

The link setting information according to the present embodiment is described below with reference to FIG. 25. FIG. 25 is a diagram illustrating an example of the link setting information according to the fourth embodiment. Link setting information 101C illustrated in FIG. 25 is an example of the link setting information set by the external server 400 when the external service provided by the external server 400 is a store service, for example.

The store service is, for example, a service that allows a user to use the image forming apparatus 600 installed in, for example, a convenience store or a drug store. In other words, the store service is a print service using the image forming apparatus 600 installed in a store.

In the present embodiment, a file name of the link setting information 101C is, for example, “MFP.json.”

In the link setting information 101C illustrated in FIG. 25, “guest+oauth” is set to the item of “oauthType” as the settings related to a QR code. In other words, the link setting information 101C is set so that guest authentication or OAuth authentication can be selected as an authentication method.

In addition, “60sec” is set to the item of “time,” and “MFP001” is set to the item of “eID.” In other words, in the link setting information 101C, a valid period of the QR code is 1 minute, and individual information for identifying print data to be printed is device identification information for identifying the image forming apparatus 600.

In the link setting information 101C, a URL of the device operation unit 260 is set to the item of “url” in an item of “mobileUI.” Accordingly, the items subsequent to the item of “url” are not set in the link setting information 101C,

In the present embodiment, by setting the QR code and the URL of the device operation unit 260 in the link setting information 101C as described above, the QR code and the device operation unit 260 can be associated with each other. Accordingly, the service link unit 250 can manage the device operation unit 260 associated with the QR code.

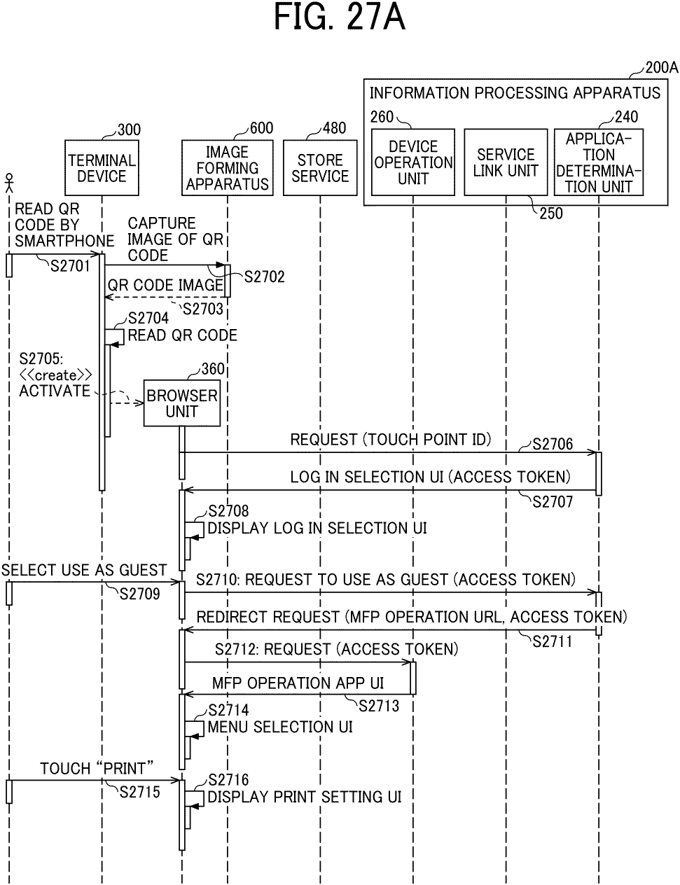

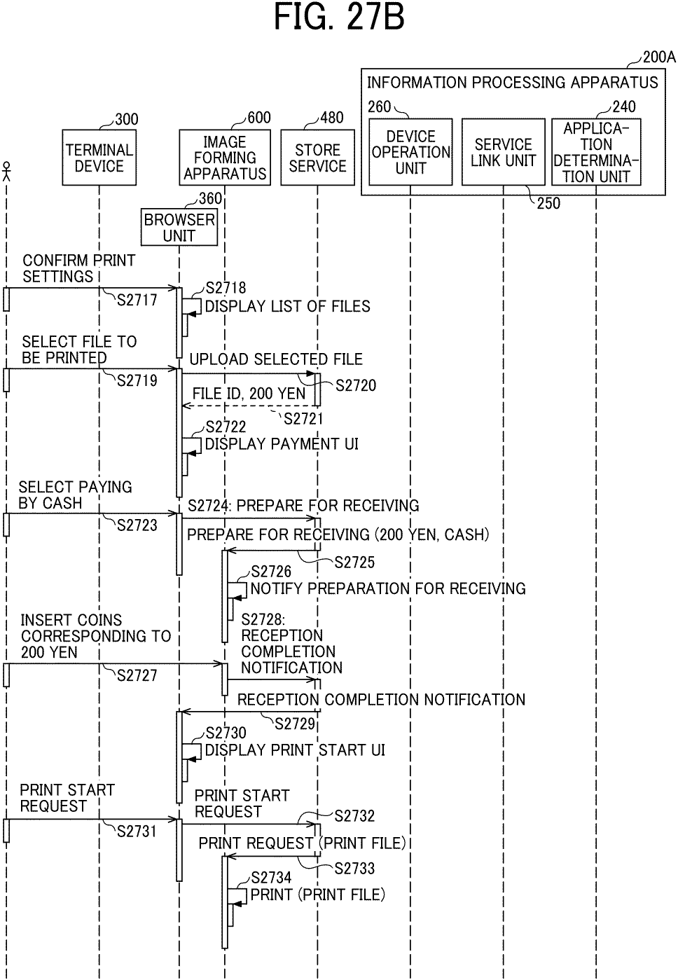

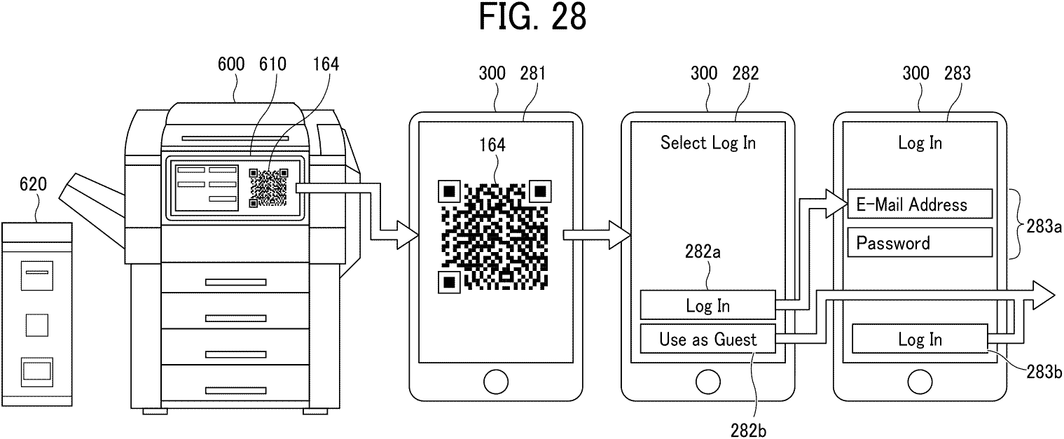

Next, processes performed by the information processing system 100A according to the present embodiment is described with reference to FIGS. 26, 27A, and 27B.

FIG. 26 is a sequence diagram illustrating a process performed by the information processing system 100A according to the fourth embodiment. Referring to FIG. 26, the process in which the information processing apparatus 200A provides a QR code including a touch point ID to a store service 480 is described.

In the present embodiment, the external service provided by the external server 400 is the store service 480. and the link setting information 101C is set by the external server 400.

An administrator of the store service 480 provided by the external server 400 acquires a tenant ID and an administrator ID, and requests the service link unit 250 to acquire an access token for linking (step S2601).

In the description of the present embodiment, the tenant ID is “tid400,” and the administrator ID is “MfpSv.”

The service link unit 250 refers to the API key storage unit 270 and transmits an API key corresponding to a combination of the tenant ID and the administrator ID to the store service 480 (step S2602).

The API key corresponding to the combination of the tenant ID of “tid400” and the administrator ID of “MfpSv” is “apikey4” (see FIG. 6). Accordingly, the service link unit 250 transmits “apikey4” to the store service 480.

Next, the image forming apparatus 600 detects that the user of the terminal device 300 has approached the image forming apparatus 600 (step S2603).

The image forming apparatus 600 may include a human-motion sensor, and the human-motion sensor may detect the approach of the user of the terminal device 300.

When detecting the approach of the user, the image forming apparatus 600 recovers from a power saving mode and makes a QR code acquisition request to the store service 480 (step S2604).

In response to receiving the acquisition request, the store service 480 makes a QR code acquisition request to the service link unit 250 (step S2605). The QR code acquisition request includes the API key “apikey4” and “MFP.json” indicating the link setting information 101C.

In response to receiving the QR code acquisition request, the service link unit 250 generates a QR code associated with MFP.json, and transmits image data representing the QR code to the store service 480 (step S2606).

Specifically, the service link unit 250 generates a touch point ID that is associated with MFP.json. Then, the service link unit 250 generates a QR code including the touch point ID and the initial access URL, and responds to the store service 480 with image data representing the QR code.

At this time, the service link unit 250 stores the touch point ID, MFP.json, and the tenant ID associated with the API key of the store service 480 in the link management storage unit 280 in association with each other.

In the present embodiment, the service link unit 250 generates the touch point ID of “tp004.”

In addition, the tenant ID associated with the API key “apikey4” of the store service 480 is “tid400.”

Accordingly, the service link unit 250 stores the touch point ID of “tp004,” the tenant ID of “tid400,” and the link setting information of “MFP.json” in association with each other in the link management storage unit 280 (see FIG. 7).

Upon acquiring the image data of the QR code, the store service 480 transmits the image data of the QR code to the image forming apparatus 600 (step S2607). The image forming apparatus 600 causes the display 610 to display the QR code (step S2608).

The above is the operation of displaying the QR code on the display 610 of the image forming apparatus 600. In the present embodiment, when the image forming apparatus 600 detects that a person has approached, a QR code acquisition request is transmitted. In addition, the QR code may be periodically updated. In the present embodiment, the QR code displayed on the image forming apparatus 600 is a dynamic QR code.

FIGS. 27A and 27B (FIG 27) are sequence diagrams illustrating a process performed by the information processing system 100A according to the fourth embodiment.

Since the processing from step S2701 to step S2706 in FIG. 27A is substantially the same as the processing from step S1201 to step S1206 in FIG. 12A except for that the PC browser 500 is the image forming apparatus 600, the description thereof is omitted.

After step S2706, the application determination unit 240 identifies the link setting information 101C (MFP.json) associated with the touch point ID included in the request in step S2706 from the link management storage unit 280, and transmits a display instruction to display a login selection screen along with the access token to the browser unit 360 based on the identified link setting information 101C (MFP.json) (step S2707).

Specifically, the application determination unit 240 causes the user to select one of the guest authentication and the OAuth authentication as the authentication method based on the setting items associated with the QR code of the link setting information 101C (MFP.json). In addition, the access token includes the temporary user ID, “guest4,” and the touch point ID.

The browser unit 360 displays a login selection screen (step S2708). In the following, a case where the guest authentication is selected as the authentication method is described.

In response to receiving the selection of guest user (step S2709), the browser unit 360 requests for use as a guest with respect to the application determination unit 240 (step S2710). The request for use includes the user ID of “guest4” and the touch point ID.

In response to receiving the request for use, the application determination unit 240 makes a redirect request to the browser unit 360 (step S2711). The redirect request includes the access token and the URL of the device operation unit 260 set to a setting related to a guide screen associated with the external service of the terminal device 300 in the link setting information 101C (MFP.json) associated with the touch point ID. The access token includes the user ID of “guest4” and the touch point ID.

In response to receiving the redirect request, the browser unit 360 makes a connection request to the device operation unit 260 (step S2712).

The device operation unit 260 transmits information for displaying an operation screen for the image forming apparatus 600 to the browser unit 360 (step S2713).

The browser unit 360 can reflect the settings of the link setting information 101C by displaying an operation menu screen for the image forming apparatus 600 (step S2714). As described above, by transmitting the link setting information 101C associated with the touch point ID to the terminal device 300, the settings related to a guide screen identified by the link setting information 101C can be reflected by settings for processing for implementing the service to be executed by the terminal device.

In the following example, a case where print is selected on the operation menu screen is described.

In response to receiving selection of “print” on the operation menu screen (step S2715), the browser unit 360 displays a print setting screen that is a screen for configures print settings (step S2716).

Subsequently, in response to receiving an operation indicating that the print settings have been confirmed (step S2717), the browser unit 360 displays a screen displaying a list of files (step S2718).

The list of files displayed may include any file that is stored in the terminal device 300 and can be printed, and may include image data and document data. The list of files displayed may be, for example, a list of files stored in a server on the Internet.

In response to receiving an operation of selecting a file to be printed from the list of files (step S2719), the browser unit 360 transmits the selected file to the store service 480 (step S2720). At this time, the browser unit 360 uploads print setting information set on the print setting screen and the device identification information for identifying the image forming apparatus 600 to the store service 480 along with the selected file.

The store service 480 determines whether the uploaded file is a file that is available for being printed, and if the upload file is a file that is available for being printed, transmits a printing cost and a file ID identifying the file to be printed to the browser unit 360 (step S2721).

The browser unit 360 displays a payment screen for paying for the printing cost (step S2722). In the present embodiment, it is assumed that a method of paying by cash is selected as a payment method for paying for the printing cost.

The payment method includes electronic payment.

When the method of paying by cash is selected as a payment method (step S2723), the browser unit 360 requests the store service 480 to designate in relation to receiving the payment (step S2724). This request includes a request for identifying the image forming apparatus 600 into which cash is to be inserted and a request for identifying an amount of money to be received. The image forming apparatus 600 is provided with a coin rack into which cash can be inserted, for example.

The store service 480 requests the image forming apparatus 600 identified by the device identification information to prepare for receiving cash (step S2725). The image forming apparatus 600 displays a message for instructing in relation to paying by cash on the display 610, cause the coin rack to prepare for receiving the cash, and enters a standby status (step S2726).

Subsequently, the image forming apparatus 600 receives the money for the printing cost when the money for the printing cost is inserted into the coin rack (step S2727), and notifies the store service 480 of completion of receiving the money for the printing cost, namely transmits the store service 480 a reception completion notification (step S2728).

In response to receiving the reception completion notification from the image forming apparatus 600, the store service 480 transmits a reception completion notification to the browser unit 360 (step S2729).

In response to receiving the reception completion notification, the browser unit 360 displays a print start screen (step S2730). In response to receiving an operation for instructing to start printing (step S2731), the browser unit 360 requests the store service 480 to start printing (step S2732).

In response to receiving the request to start printing, the store service 480 transmits a print request for the selected file to the image forming apparatus 600 (step S2733). In response to the print request, the image forming apparatus 600 prints out the selected file (step S2734).

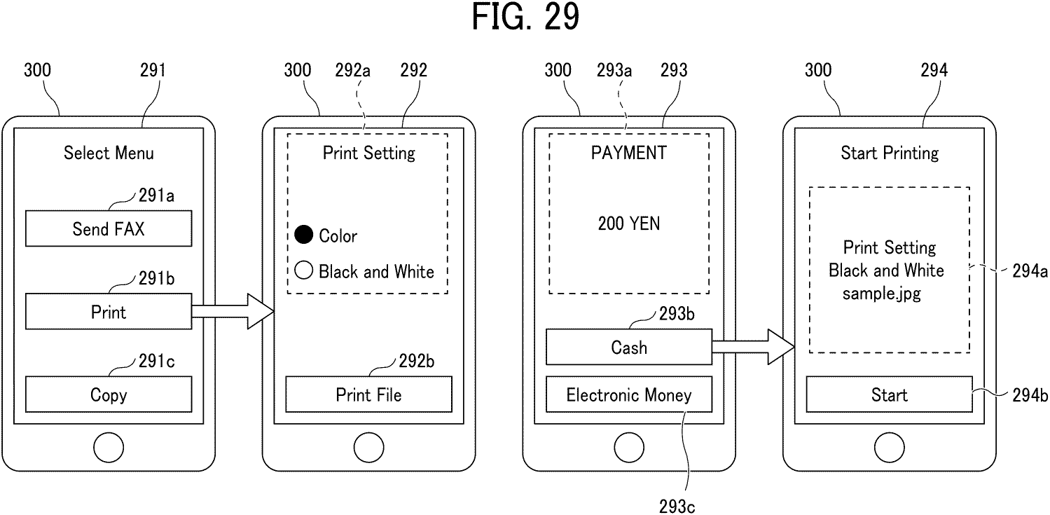

Screen transition according to the present embodiment is described below with reference to FIGS. 28 and 29. FIG. 28 is a diagram illustrating an example of a screen transition according to the fourth embodiment.

The image forming apparatus 600 illustrated in FIG. 28 includes the display 610 and a coin rack 620. In the example of FIG. 28, the image forming apparatus 600 detects the approach of the user of the terminal device 300 and displays the QR code 164 on the display 610.

When the terminal device 300 displays the QR code 164 on a screen 281 and reads the QR code 164, the screen 281 transitions to a screen 282.

The screen 282 is an example of a login selection screen, and is displayed by the browser unit 360 in step S2707 in FIG. 27A.

The screen 282 includes operation buttons 282a and 282b. The operation button 282a is an operation button for selecting a method of logging in by inputting account information registered in advance.

The operation button 282b is an operation button for selecting a method of logging in as a guest user.

In the present embodiment, whether to use history indicating use in the past and a method of paying for the print cost may differ depending on the login method. For example, when the user logs in by inputting account information, history of files that has been printed in the past can be displayed, and print setting information indicating previous print settings can be used. In addition, when account information is input and login is performed, a payment method registered in advance can be selected as a payment method.

In this embodiment, when the user logs in as a guest user, the history indicating use in the past is not displayed, and a payment method is to be by cash or electronic money.

When the operation button 282a is operated on the screen 282, the screen 282 transitions to a screen 283. which is described later. When the operation button 282b is operated on the screen 282, the screen 282 transitions to a screen 291, which is described later.

The screen 283 includes an input field 283a for inputting account information and an operation button 283b for requesting the store service 480 to authenticate the account information. When account information is input to the input field 283a and the operation button 283b is operated on the screen 283, the screen 283 transitions to the screen 291.

FIG. 29 is a diagram illustrating an example of a screen transition according to the fourth embodiment. The screen 291 illustrated in FIG. 29 is an example of an operation menu screen, and is displayed by the browser unit 360 in step S2714 in FIG. 27A.

The screen 291 includes operation buttons 291a. 291b, and 291c. The operation button 291a is an operation button for selecting facsimile (FAX) transmission by the image forming apparatus 600. The operation button 291b is an operation button for selecting printing by the image forming apparatus 600. The operation button 291c is an operation button for selecting copying by the image forming apparatus 600.

In the present embodiment, for example, the operation button 291b is selected. When the operation button 291b is selected, the screen 291 transitions to a screen 292. The screen 292 is an example of a print setting screen, and is displayed by the browser unit 360 in step S2716 in FIG. 27A.

The screen 292 includes a display area 292a and an operation button 292b. A menu of print settings is displayed in the display area 292a. On the screen 292. color printing is selected. On the screen 292, when print setting is set in the display area 292a and the operation button 292b is operated, a file list screen is displayed by the browser unit 360.

A screen 293 is an example of a screen displayed by the browser unit 360 after a file to be printed is selected on the file list screen and the file to be printed is uploaded to the store service 480.

Specifically, the screen 293 is an example of a payment screen for paying for the print cost, and is displayed by the browser unit 360 in step S2722 in FIG. 27B.

The screen 293 includes a display area 293a and operation buttons 293b and 293c. In the display area 293a, the printing cost for printing out the file to be printed is displayed. The operation buttons 293b and 293c are operation buttons for selecting a payment method for paying for the printing cost. The operation button 293b is an operation button for selecting paying by cash, and the operation button 293c is an operation button for selecting paying by electronic money.

In FIG. 29, it is assumed that paying by cash is selected. When the operation button 293b is selected on the screen 293 and the image forming apparatus 600 completes receiving the money for the print cost, a screen 294 is displayed by the browser unit 360.

The screen 294 is an example of a print start screen, and is displayed by the browser unit 360 in step S2730 in FIG. 27B.

The screen 294 includes a display area 294a and an operation button 294b. In the display area 294a, the print setting information set to the file to be printed and a file name of the file to be printed are displayed. The operation button 294b is an operation button for making a print request.

When the operation button 294b is operated on the screen 294, the browser unit 360 transmits the print request to the store service 480. In response to receiving the print request, the store service 480 instructs the image forming apparatus 600 to start printing, and causes the image forming apparatus 600 to print the file to be printed selected in the terminal device 300.

As described above, in the present embodiment, the service link unit 250 is linked with the device operation unit 260 to cause the terminal device 300 to operate the image forming apparatus 600 via the device operation unit 260.

Accordingly, in the present embodiment, the user of the terminal device 300 can use the image forming apparatus 600 without installing a dedicated application for operating the image forming apparatus 600 installed in the store.

In the present embodiment, data selected by the terminal device 300 can be output as a printed matter by the image forming apparatus 600.

In the present embodiment, the URL of the device operation unit 260 for operating the image forming apparatus 600 is set to the item of “url” of a setting related to the guide screen corresponding to the external service of the terminal device 300 in the link setting information 101C A URL of any web application may be set to the item of “url” of the link setting information 101C.

Specifically, for example, a web application of which the URL is set to the item of “url” may be a web application for operating a projector or an electronic whiteboard.

The web application of which the URL is set to the item of “url” may be any application as long as it is an application that manages or operates a device that outputs data acquired by the terminal device 300.

In a system according to a related art, when a server links with an external service and provides image data acquired by a terminal device to the external service, the image data to be provided to the external server does not reflects settings suitable for the external service. Due to this, in such a system according to the related art, when various types of external services are provided, the image data acquired by the terminal device fails to flexibly reflect the settings suitable for each of the various types of external services.

According to an embodiment of the disclosure, image data acquired by a terminal device can reflect settings suitable for an external service linked with an information processing apparatus when the external service is provided.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The apparatuses or devices described in the embodiments described above are merely one example of plural computing environments that implement one or more embodiments of the disclosure.

In some embodiments, the information processing apparatus 200 includes multiple computing devices, such as a server cluster. The multiple computing devices are configured to communicate with one another through any type of communication link, including a network, a shared memory, etc., and perform the processes disclosed herein. In substantially the same manner, for example, the information processing apparatus 200 includes such multiple computing devices configured to communicate with one another.

Further, the information processing apparatus 200 can be configured to share the disclosed processes in various combinations. For example, a process executed by a particular unit may be executed by the information processing apparatus 200. Similarly, a function of a particular unit may be performed by information processing apparatus 200. Each element of the information processing apparatus 200 may be integrated into one server device or may be divided into a plurality of devices.

Note that the information processing apparatus 200 is not limited to an image forming apparatus as long as the apparatus has a communication function. The information processing apparatus 200 includes, for example, an output device such as a projector (PJ), an Interactive White Board (a white board having an electronic whiteboard function capable of mutual communication (IWB)), and a digital signage, a Head Up Display (HUD) device, an industrial machine, an imaging device, a sound collecting device, a medical device, a network home appliance, an automobile (connected car), a notebook Personal Computer (PC), a mobile phone, a smartphone, a tablet terminal, a game console, a Personal Digital Assistant (PDA), a digital camera, a wearable PC or a desktop PC.

Aspects of the present disclosure are, for example, as follows.

### Aspect 1

In Aspect 1, an information processing apparatus includes a reception unit to receive, from a terminal device, identification information associated with link setting information that is information for identifying settings corresponding to an external service.

The information processing apparatus includes a transmission unit to transmit, to the terminal device, an execution request to execute processing for implementing a service for uploading image data that is acquired by the terminal device, based on the identification information.

The transmission unit transmits the link setting information associated with the received identification information to the terminal device so that the settings identified by the link setting information are reflected in settings for the processing for implementing the service executed by the terminal device.

### Aspect 2

In Aspect 2, in the information processing apparatus according to Aspect 1, the processing for implementing the service includes causing the image data acquired by the terminal device to be uploaded based on the settings identified by the link setting information associated with the identification information.

### Aspect 3

In Aspect 3, in the information processing apparatus according to Aspect 2, the image data acquired by the terminal device includes image data representing an image that is captured by an image capturing function of the terminal device. The image capturing function is activated in response to the execution request.

### Aspect 4

In Aspect 4, the information processing apparatus according to any one of Aspect 2 and Aspect 3 further includes a service link unit.

When the image data is uploaded from the terminal device, the service link unit sets the image data to have a configuration corresponding to the external service and notifies an external server that provides the external service of a URL indicating a storage location of the image data having the configuration corresponding to the external service.

### Aspect 5

In Aspect 5, in the information processing apparatus according to Aspect 4, the service link unit stores, in the storage location, the image data uploaded from the terminal device as one having the configuration corresponding to the external service.

### Aspect 6

In Aspect 6, in the information processing apparatus according to any one of Aspect 4 and Aspect 5, the service link unit generates a two dimensional code including the identification information and outputs the two dimensional code to the external server.

The reception unit receives, from the terminal device, the identification information read through the two dimensional.

### Aspect 7

In Aspect 7, in the information processing apparatus according to any one of Aspect 4 to Aspect 6, the link setting information includes setting information related to an authentication method for authenticating a user of the terminal device.

The service link unit displays, on the terminal device, an authentication screen that varies depending on content of the setting information related to the authentication method.

### Aspect 8

In Aspect 8, in the information processing apparatus according to any one of Aspect 4 to Aspect 7. the link setting information includes additional setting information related to a guide screen for uploading the image data acquired by the terminal device. The service link unit cause the terminal device to display the guide screen based on the additional setting information related to the guide screen.

### Aspect 9

In Aspect 9, in the information processing apparatus according to Aspect 8, in a case that the additional setting information related to the guide screen includes a setting of a URL of a web application, the service link unit displays, on the terminal device, a screen of the web application.

### Aspect 10

In Aspect 10, in the information processing apparatus according to any one of Aspect 4 to Aspect 9. the link setting information includes setting information for causing the terminal device to perform recognition processing on the image data acquired by the terminal device. The image data uploaded from the terminal device is image data obtained after the recognition processing is performed by the terminal device.

### Aspect 11

In Aspect 11, in the information processing apparatus according to Aspect 10, the recognition processing includes a plurality of types of processing.

The link setting information includes additional setting information for causing the terminal device to perform all of the plurality of types of processing of the recognition processing.

The image data uploaded from the terminal device is image data obtained after all of the plurality of types of processing is performed by the terminal device.

### Aspect 12

In Aspect 12. in the information processing apparatus according to Aspect 10, the recognition processing includes a plurality of types of processing.

The link setting information includes additional setting information for causing the terminal device to perform a part of the plurality of types of processing of the recognition processing.

The image data uploaded from the terminal device is image data obtained after the part of the plurality of types of processing is executed by the terminal device.

### Aspect 13

In Aspect 13, in the information processing apparatus according to Aspect 10, the link setting information includes additional setting information for causing the terminal device to reduce a size of the image data acquired by the terminal device,

The image data uploaded from the terminal device is image data obtained after being reduced by the terminal device.

### Aspect 14

In Aspect 14, in the information processing apparatus according to any one of Aspect 4 to Aspect 13, the link setting information includes setting information related to information to be added to the URL of the storage location of the image data having the configuration corresponding to the external service.

The service link unit notifies the external server that provides the external service of an additional URL of an additional storage location of the image data acquired by the terminal device in addition to the URL of the storage location of the image data having the configuration corresponding to the external service based on the setting information related to the information to be added.

### Aspect 15

In Aspect 15, in the information processing apparatus according to Aspect 14, the service link unit notifies the external server that provides the external service of another additional URL of another additional storage location of additional image data that is acquired again by the terminal device, based on the setting information related to the additional information.

### Aspect 16

In Aspect 16, in the information processing apparatus according to Aspect 14, the service link unit notifies the external server that provides the external service of information for identifying the terminal device based on the setting information related to the information to be added.

### Aspect 17

In Aspect 17, an information processing system includes a terminal device and an information processing apparatus.

The information processing apparatus includes a reception unit to receive, from a terminal device, identification information associated with link setting information that is information for identifying settings corresponding to an external service.

The information processing apparatus includes a transmission unit to transmit, to the terminal device, an execution request to execute processing for implementing a service for uploading image data acquired by the terminal device, based on the identification information.

The transmission unit transmits the link setting information associated with the received identification information to the terminal device so that the settings identified by the link setting information is reflected in settings for the processing for implementing the service executed by the terminal device.

The terminal device includes a display unit to display, on a display, a guide screen for uploading the image data corresponding to the external service.

### Aspect 18

In Aspect 18, an information processing method performed by an information processing apparatus includes receiving, from a terminal device, identification information associated with link setting information that is information for identifying settings corresponding to an external service, and transmitting, to the terminal device, an execution request to execute processing for implementing a service of uploading image data acquired by the terminal device, based on the identification information.

The transmitting includes transmitting the link setting information associated with the received identification information to the terminal device so that the settings identified by the link setting information is reflected in the settings of the processing for implementing the service executed by the terminal device.

### Aspect 19

In Aspect 19, a program implementing processing including receiving, from a terminal device, identification information associated with link setting information that is information for identifying settings corresponding to an external service, and transmitting, to the terminal device, an execution request to execute processing for implementing a service of uploading image data acquired by the terminal device, based on the identification information.

The transmitting including transmitting the link setting information associated with the received identification information to the terminal device so that the settings identified by the link setting information is reflected in settings for the processing for implementing the service executed by the terminal device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above

1. An information processing apparatus, comprising circuitry configured to:
receive, from a terminal device, identification information associated with link setting information that is information for identifying settings corresponding to an external service;
transmit, to the terminal device, an execution request to execute processing for implementing a service for uploading image data that is acquired by the terminal device, based on the identification information; and
transmit, to the terminal device, the link setting information associated with the identification information to cause the terminal device to reflect the settings identified by the link setting information in additional settings for the processing for implementing the service, the processing for implementing the service being to be executed by the terminal device.

2. The information processing apparatus of claim 1, wherein
the processing for implementing the service includes causing the image data acquired by the terminal device to be uploaded based on the settings identified by the link setting information associated with the identification information.

3. The information processing apparatus of claim 2, wherein
the image data acquired by the terminal device includes image data representing an image that is captured by an image capturing function of the terminal device, the image capturing function being activated in response to the execution request.

4. The information processing apparatus of claim 3, wherein
the circuitry is further configured to implement the service, and
in response to upload of the image data from the terminal device, the circuitry further
sets the image data to have a configuration corresponding to the external service, and
notifies, an external server providing the external service of a uniform resource locator (URL) indicating a storage location at which the image data having the configuration corresponding to the external service is stored.

5. The information processing apparatus of claim 4, wherein
the circuitry is further configured to store, at the storage location, the image data uploaded from the terminal device as one having the configuration corresponding to the external service.

6. The information processing apparatus of claim 4, wherein
the circuitry is further configured to:
generate a two dimensional code including the identification information;
output the two dimensional code to the external server; and
receive, from the terminal device, the identification information read through the two dimensional code.

7. The information processing apparatus of claim 6, wherein
the link setting information includes setting information related to an authentication method for authenticating a user of the terminal device, and
the circuitry is further configured to display, on the terminal device, an authentication screen that varies depending on content of the setting information related to the authentication method.

8. The information processing apparatus of claim 7, wherein
the link setting information includes additional setting information related to a guide screen for uploading the image data acquired by the terminal device, and
the circuitry is further configured to display, on the terminal device, the guide screen based on the additional setting information related to the guide screen.

9. The information processing apparatus of claim 8, wherein,
in a case that the additional setting information related to the guide screen includes a setting of a URL of a web application, the circuitry is further configured to display, on the terminal device, a screen of the web application.

10. The information processing apparatus of claim 4, wherein
the link setting information includes setting information for causing the terminal device to perform recognition processing on the image data acquired by the terminal device, and
the image data uploaded from the terminal device is one obtained after the recognition processing is performed by the terminal device.

11. The information processing apparatus of claim 10, wherein
the recognition processing includes a plurality of types of processing,
the link setting information includes additional setting information for causing the terminal device to perform all of the plurality of types of processing of the recognition processing, and
the image data uploaded from the terminal device is the one obtained after all of the plurality of types of processing is performed by the terminal device.

12. The information processing apparatus of claim 10, wherein
the recognition processing includes a plurality of types of processing, and
the link setting information includes additional setting information for causing the terminal device to perform a part of the plurality of types of processing of the recognition processing, and
the image data uploaded from the terminal device is the one obtained after the part of the plurality of types of processing is performed by the terminal device.

13. The information processing apparatus of claim 10, wherein
the link setting information includes additional setting information for causing the terminal device to reduce a size of the image data acquired by the terminal device,
the image data uploaded from the terminal device is one obtained after being reduced by the terminal device.

14. The information processing apparatus of claim 4, wherein
the link setting information includes setting information related to information to be added to the URL of the storage location of the image data having the configuration corresponding to the external service, and
the circuitry is further configured to notify the external server providing the external service of an additional URL of an additional storage location of the image data acquired by the terminal device in addition to the URL of the storage location of the image data having the configuration corresponding to the external service, based on the setting information related to the information to be added.

15. The information processing apparatus of claim 14, wherein
the circuitry is further configured to notify the external server providing the external service of another additional URL of another additional storage location of additional image data that is acquired again by the terminal device, based on the setting information related to the information to be added.

16. The information processing apparatus of claim 14, wherein
the circuitry is further configured to notify the external server providing the external service of information for identifying the terminal device, based on the setting information related to the information to be added.

17. An information processing system, comprising:
the information processing apparatus of claim 1; and
a terminal device configured to display, on a display, a guide screen for uploading the image data corresponding to the external service.

18. An information processing method, comprising:
receiving, from a terminal device, identification information associated with link setting information that is information for identifying settings corresponding to an external service;
transmitting, to the terminal device, an execution request to execute processing for implementing a service of uploading image data acquired by the terminal device, based on the identification information; and
transmitting, to the terminal device, the link setting information associated with the identification information to cause the terminal device to reflect the settings identified by the link setting information in additional settings that is for the processing for implementing the service, the processing for implementing the service being to be executed by the terminal device.

19. A non-transitory recording medium storing a plurality of instructions which, when executed by one or more processors, causes the processors to perform a method, the method comprising:
receiving, from a terminal device, identification information associated with link setting information that is information for identifying settings corresponding to an external service;
transmitting, to the terminal device, an execution request to execute processing for implementing a service of uploading image data acquired by the terminal device, based on the identification information; and
transmitting, to the terminal device, the link setting information associated with the identification information to cause the terminal device to reflect the settings identified by the link setting information in additional settings that is for the processing for implementing the service, the processing for implementing the service being to be executed by the terminal device.
